(19) United States
(12) Patent Application Publication
(10) Pub. No.: US 2011/0090253 A1
(43) Pub. Date: Apr. 21, 2011

(54) AUGMENTED REALITY LANGUAGE TRANSLATION SYSTEM AND METHOD

(75) Inventor: Otavio Good, San Francisco, CA (US)

(73) Assignee: QUEST VISUAL, INC., San Francisco, CA (US)

(21) Appl. No.: 12/907,672

(22) Filed: Oct. 19, 2010

Related U.S. Application Data
(60) Provisional application No. 61/253,026, filed on Oct. 19, 2009.

(51) Int. Cl. G09G 5/00

(52) U.S. Cl. 345/633

(57) ABSTRACT

A real-time augmented-reality machine translation system and method are provided herein.

### CROSS REFERENCE TO RELATED APPLICATIONS

This application claims the benefit of priority to Provisional Application No. 61/253,026, filed Oct. 19, 2009, titled “Augmented Reality Language Translation System and Method,” having Attorney Docket No. QUES-2009002, and naming inventor Otavio Good. The above-cited application is incorporated herein by reference in its entirety, for all purposes.

### FIELD

The present disclosure relates to machine language translation, and more particularly to a system and method for providing real-time language translation via an augmented reality display.

### BACKGROUND

Tourists and other travelers frequently visit countries where they do not speak the language. In many cases, not speaking the local language can present challenges to a traveler, including his or her not being able to read and understand signs, schedules, labels, menus, and other items that provide potentially useful information via a text display. Currently, many such travelers rely on electronic or printed phrase books and translation dictionaries to help them comprehend text displayed in a foreign language.

However, as “smart” mobile phones and other mobile devices become more prevalent and more powerful, it is becoming possible to automate at least some of a traveler's written-word translation needs using image capture and machine translation technologies. For example, in 2002, researchers at IBM developed a prototype “infoscope” that allowed a user to take a still picture of a sign with foreign language text, transmit the picture across a wireless network to a server, and receive a machine-translation of the text in the picture from the server in as little as fifteen seconds. A similar server-based machine translation scheme is embodied in “Shoot & Translate,” a commercial software program produced by Linguatec Language Technologies of Munich Germany for Internet-enabled mobile phones and PDAs.

However, there are at least two disadvantages with server-based machine translation schemes such as those discussed above. First, an Internet connection is required to send the picture to the machine translation server. Needing an Internet connection may be disadvantageous because cellular data coverage may not be available in all areas, and even if a data network is available, exorbitant data “roaming” charges may make use of the data network cost-prohibitive. Second, there is typically a delay associated with server-based machine translation because the picture must be transmitted across a mobile data network that may be slow and/or unreliable. Furthermore, the machine translation server may add additional delays, as it may be trying to service a large number of simultaneous translation requests.

Despite these disadvantages, server-based machine translation has been the model for most (if not all) existing mobile translation systems at least in part because of limitations in processing power available on mobile phones, PDAs, and other mobile devices. Indeed, even the most powerful of the current generation of “smart” mobile phones are generally regarded to lack processing capacity sufficient to perform real-time text-recognition and translation services using existing techniques.

### BRIEF DESCRIPTION OF THE DRAWINGS

FIG. 1 is a system diagram illustrating several components of an exemplary Augmented Reality (“AR”) translating device in accordance with one embodiment.

FIG. 2 illustrates an AR translation routine 200 in accordance with one embodiment.

FIG. 3 illustrates a frame-processing and text-line identification subroutine, in accordance with one embodiment.

FIG. 4 illustrates a subroutine 400 for identifying words within an image of a line of text, in accordance with one embodiment.

FIG. 5 illustrates a fuzzy glyph-identification subroutine, in accordance with one embodiment.

FIG. 6 illustrates a glyph-candidate horizontal centers of gravity processing subroutine, in accordance with one embodiment.

FIG. 7 is a flow diagram illustrating a fuzzy-string match subroutine in accordance with one embodiment.

FIG. 8 illustrates an unlikely-candidate elimination subroutine, in accordance with one embodiment.

FIG. 9 illustrates a string-comparison subroutine in accordance with one embodiment.

FIG. 10 illustrates an augmented reality overlay subroutine in accordance with one embodiment.

FIG. 11 illustrates an ordered list of possible character matches for glyph candidates corresponding to the word “BASURA,” in accordance with one embodiment.

FIGS. 12-21 include various images and bitmaps illustrating by way of example various aspects of the AR translations systems and methods discussed herein.

### DESCRIPTION

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

In various embodiments, it may be desirable to perform text recognition and machine translation from a first language into a target language interactively in or near real-time from frames of a video stream, such as may be captured by a mobile device. It may be further desirable to render the translated text as a synthetic graphical element overlaid on the captured video stream as it is displayed to the user, displaying a view of the captured text as it would appear in the real world if it had been written in the target language.

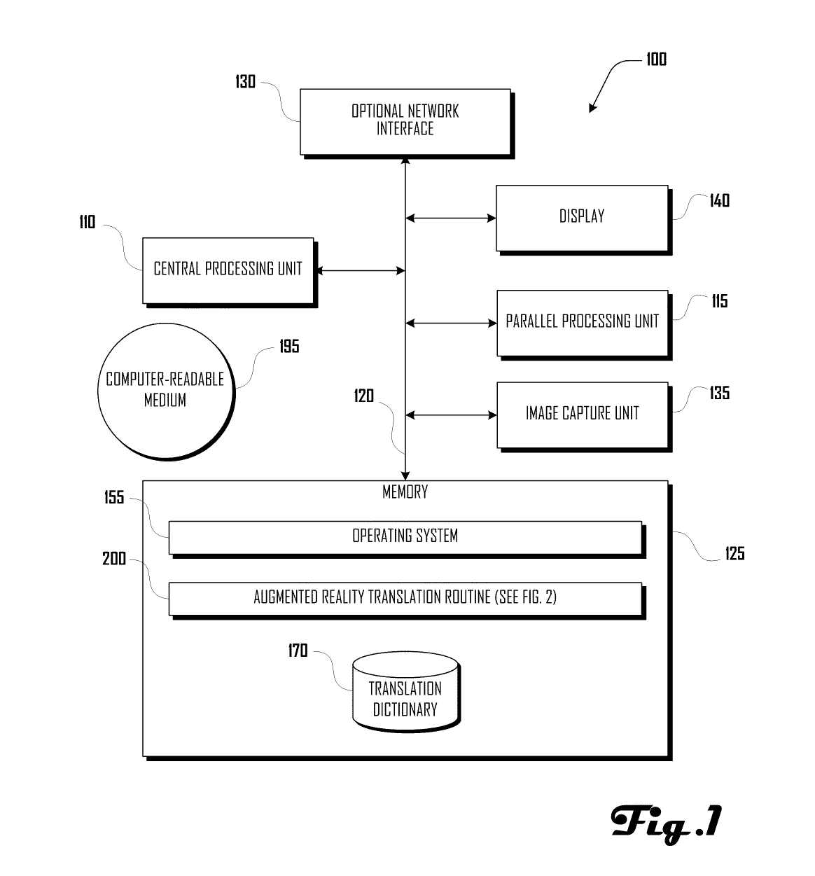

In one embodiment, such a mixed-reality or augmented-reality (“AR”) translation may be implemented locally on a personal mobile device (e.g. AR translating device 100, as illustrated in FIG. 1, discussed below) typically carried on a user's person, such as a mobile phone, game device, media play and/or record device, PDA, and the like. In some embodiments, a mobile device may have a general purpose central processing unit (“CPU”) powerful enough to perform the necessary translation operations in or near real time. In other embodiments, a mobile device may perform certain portions of the translation process on a graphics processing unit (“GPU”) or other parallel and/or stream processing component that can be adapted to perform the necessary operations. In still other embodiments, a mobile device may perform parallel operations using multiple CPUs and/or a multi-core CPU.

FIG. 1 illustrates several components of an exemplary AR translating device 100 in accordance with an exemplary embodiment. In some embodiments, AR translating device 100 may include many more components than those shown in FIG. 1. However, it is not necessary that all of these generally conventional components be shown in order to disclose an illustrative embodiment. As shown in FIG. 1, AR translating device 100 includes an optional network interface 130 for connecting to a network (not shown). If present, network interface 130 includes the necessary circuitry for such a connection and is constructed for use with an appropriate protocol.

AR translating device 100 also includes a central processing unit 110, a parallel processing unit 115, an image capture unit 135, a memory 125, and an associated display 140, all interconnected, along with optional network interface 130, via bus 120. In some cases, bus 120 may include a local wireless bus connecting central processing unit 110 with nearby, but physically separate, components, such as image capture unit 135, a associated display 140, or the like. Image capture unit 135 generally comprises a charge-coupled device (“CCD”), an active-pixel sensor (“APS”), such as a complementary metal-oxide-semiconductor (“CMOS”) image sensor, and the like. Memory 125 generally comprises a random access memory (“RAM”), a read only memory (“ROM”), one or more permanent mass storage devices, such as a disk drive and/or flash memory. In some embodiments, memory 125 may also comprise a local and/or remote database, database server, and/or database service. Similarly, central processing unit 110 and/or parallel processing unit 115 may be composed of numerous physical processors and/or it may comprise a service operated by a distributed processing facility. In various embodiments, parallel processing unit 115 may include a graphics processing unit (“GPU”), a media co-processor, and/or other single instruction, multiple data (“SIMD”) processor.

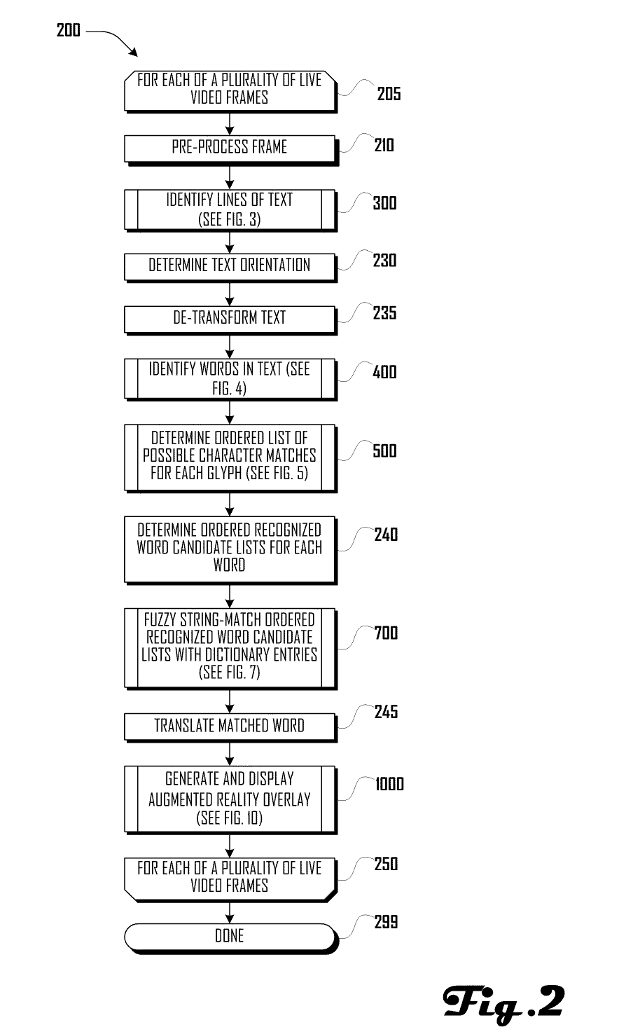

Memory 125 stores program code for an augmented reality (“AR”) translation routine 200, as illustrated in FIG. 2 and discussed below. These and other software components may be loaded from a non-transient computer readable storage medium 195 into memory 125 of device 100 using a drive mechanism (not shown) associated with the computer readable storage medium 195, such as a floppy disc, tape, DVD/CD-ROM drive, memory card, and the like. In some embodiments, software components may also be loaded via the network interface 130, another communications interface (not-shown), and/or other non-storage media. Memory 125 may also contain a translation dictionary 170.

FIG. 2 illustrates an AR translation routine 200 in accordance with one embodiment. In beginning loop block 205, routine 200 iterates over a plurality of live video frames. For example, in one embodiment, routine obtains a series of frames captured by image capture unit 135 and processes some or all of the frames before they are displayed to the user. In some embodiments, routine 200 may process frames at a slower rate than image capture unit 135 captures them. For example, in one embodiment, image capture unit 135 may capture 30 frames per second, but routine 200 may process only every other frame, displaying translated frames at 15 frames per second. In other embodiments, routine 200 may translate fewer frames per second (e.g., three or four frames per second), while AR translating device 100 further performs a motion tracking routine (not shown) to smooth transitions between translated frames.

In block 210, routine 200 pre-processes the frame to prepare it for subsequent operations. In one embodiment, routine pre-processes the frame by converting it to grayscale (if the original frame was in color) and optionally down-sampling the frame to further reduce the amount of data to be processed. In one embodiment, the frame may comprise approximately three megapixels of image data, and routine 200 may down-sample the frame by a factor of two. Other embodiments may start with a smaller or larger image and may down-sample by a smaller of larger factor.

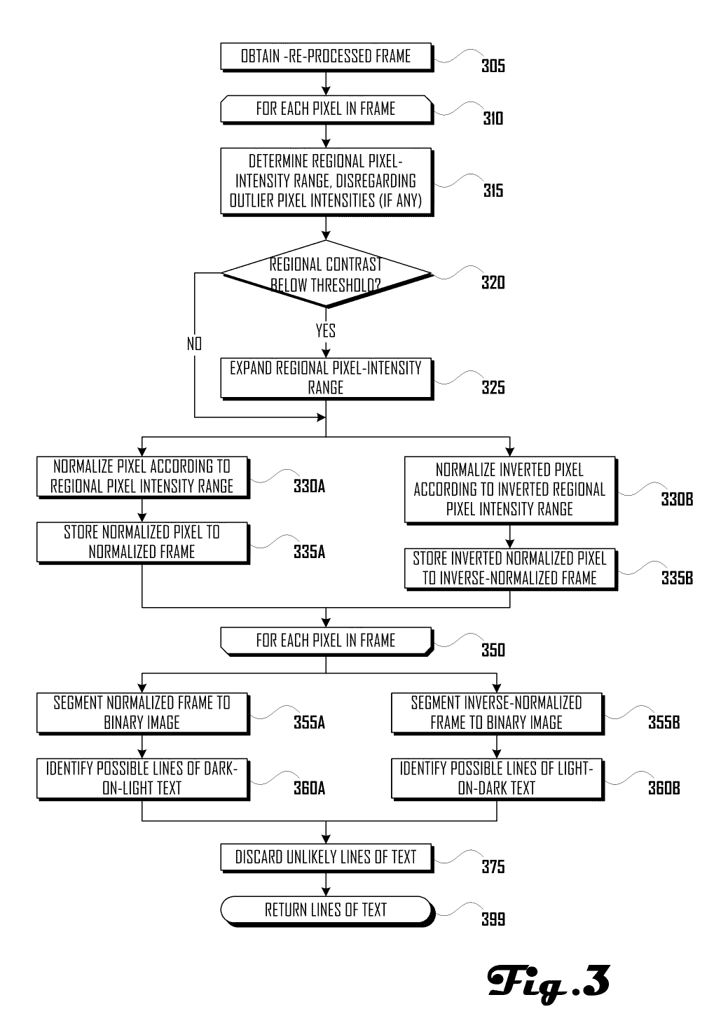

In subroutine block 300 (see FIG. 3, discussed below), routine 200 further processes the current frame and identifies one or more lines of text depicted in the frame.

In block 230, routine 200 determines the orientation of the lines of text identified by subroutine 300.

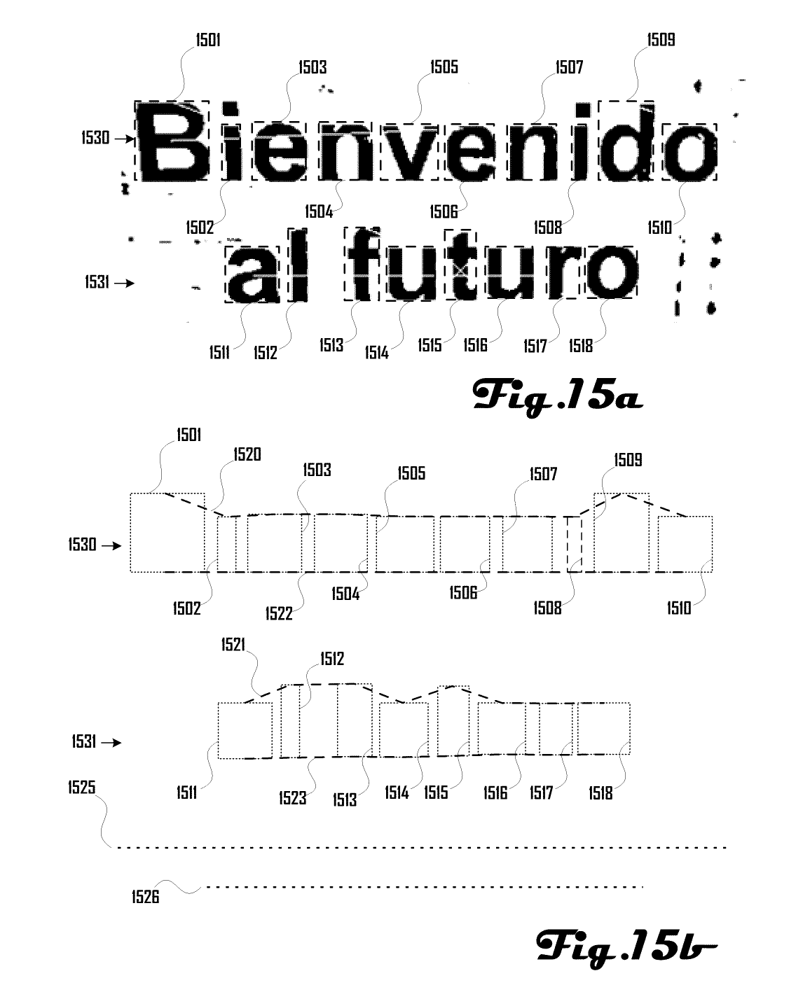

In one embodiment, determining the text orientation may include determining horizontal orientation using connectivity between neighboring glyph bounding boxes. For example, FIGS. 15a-b illustrate horizontal alignment determined in such a manner. FIG. 15a illustrates two lines of text 1531-1531 comprising several glyphs surrounded by imaginary bounding boxes 1501-1518. FIG. 15b illustrates bounding boxes 1501-1518 (corresponding to lines of text 1531-1531), as well as connected lines 1520-1523. Connected lines 1520-1521 are made up of line segments connecting the centers of the tops of bounding boxes 1501-1518. Connected lines 1522-1523 are made up of line segments connecting the centers of the bottoms of bounding boxes 1501-1518. Horizontal orientation 1525 corresponds to bounding boxes 1501-1510. In one embodiment, horizontal orientation 1525 may be determined by determining a median tilt of some or all of the segments comprising one or both of connected lines 1520 and 1522. Similarly, in one embodiment, horizontal orientation 1526 may be determined by determining a median tilt of some or all of the segments comprising one or both of connected lines 1521 and 1523.

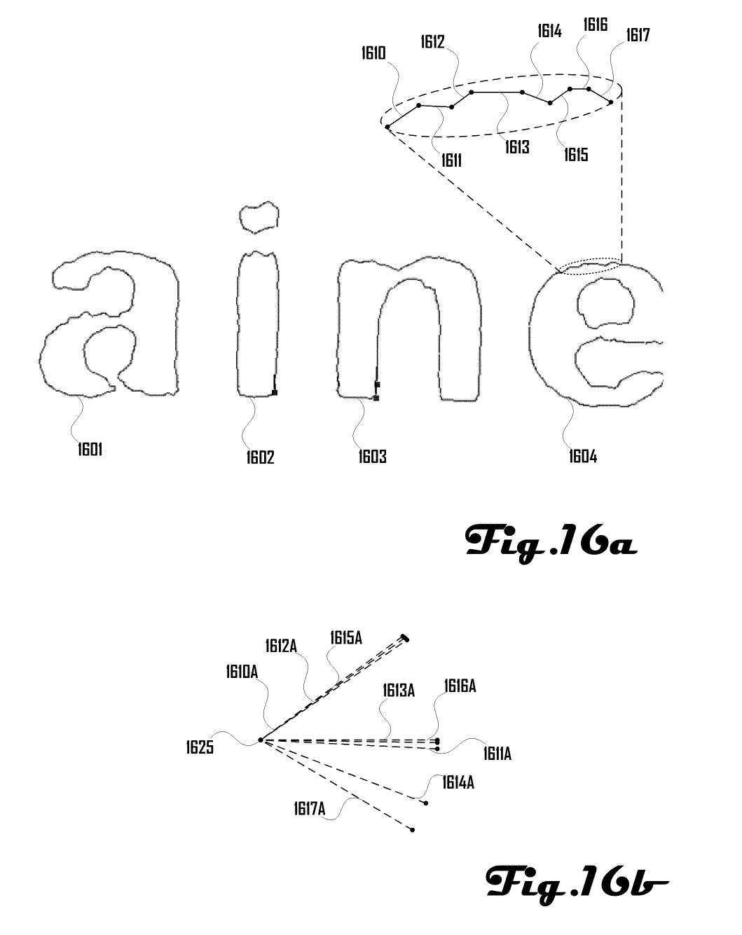

In one embodiment, determining the text orientation may include determining a vertical orientation by vectorizing some or all glyphs identified by subroutine 300 and processing the resulting vectorized outlines. For example, FIG. 16a depicts four glyphs 1601-1604 having vectorized outlines. In the illustrated example, the vectorized outlines consist of many short (about four pixels long) connected line segments, e.g. 1610-1617. In one embodiment, such vectorized outline line segments may be determined using a two-dimensional marching cubes algorithm (i.e., “marching squares”) or other suitable approach.

Groups of letters in the Latin alphabet tend to be dominated by vertical lines in many common fonts. Taking advantage of this property, in one embodiment, the verticality of a word or line of words written using the Latin alphabet may be determined according to the respective tilts of the line segments that make up the vectorized outlines of the word or line's component glyphs. For example, FIG. 16b depicts the respective tilts 1610A-1617A of each line segment 1610-1617, plotted from a single point 1625. In some embodiments, the vertical orientation of one or more glyphs (e.g. 1601-1604) may be estimated by averaging the tilts (or taking the median or another statistical measure) of a subset of generally-vertical tilt vectors (e.g., those vectors whose tilts are within 45 degrees of vertical) corresponding to a vectorized glyph outline. In some embodiments, horizontal orientations (e.g. 1525-1526 as illustrated in FIG. 15b) may also be used to help determine vertical orientations.

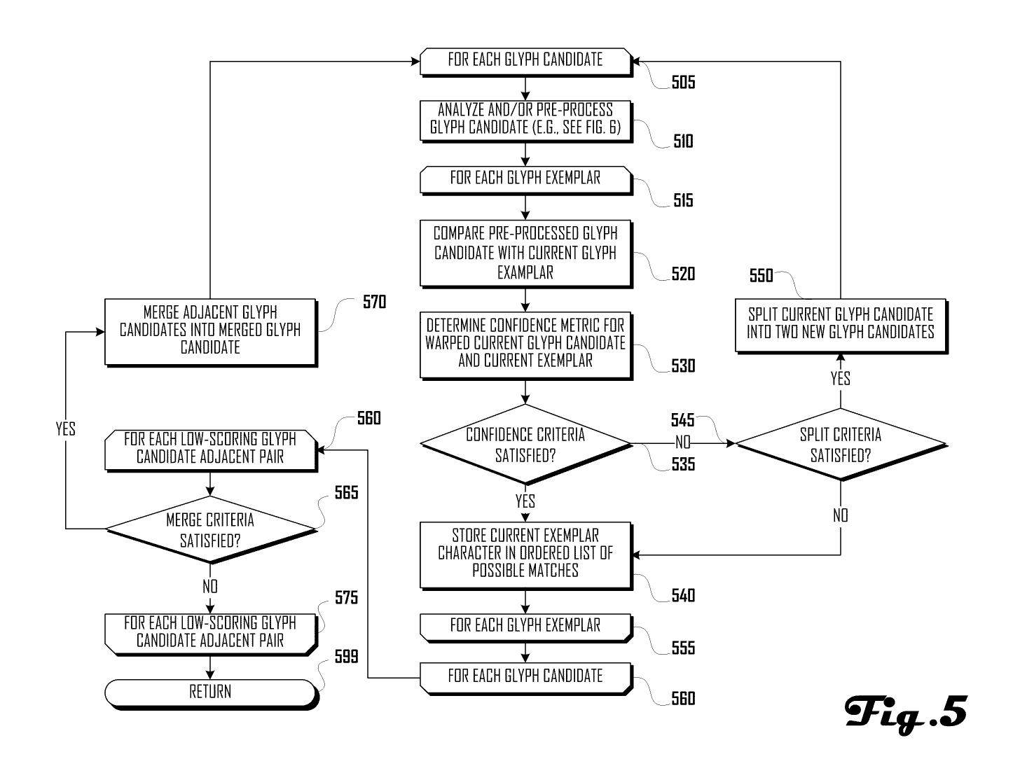

(Unlike many common optical character recognition processes, in some embodiments, vectorized glyphs used only to determine text alignment, not for comparison against vectorized glyph exemplars. Rather, in such embodiments, glyph comparisons may be performed as described below in reference to FIG. 5.)

Referring again to block 230 in FIG. 2, in some embodiments, routine 200 may determine more than one vertical vectors for long lines of text. When captured from certain vantage points, perspective may cause vertical vectors to diverge from one end of a line of text to the other end. To accommodate such perspective distortions, in some embodiments, routine 200 may split “long” lines of text into two or more portions and determine vertical vectors for each individual portion. In one embodiment, a line may be considered “long” if it includes more than about ten glyphs. In some embodiments, when a “long” line of text has been split into two or more portions, the vertical vector for any particular glyph may be determined by interpolating between (or otherwise combining) adjacent vertical vectors.

In block 235, routine 200 de-transforms text in the frame according to the glyph bounding boxes and orientations determined in blocks 300 and 230. In this context, “de-transforming” the text means to map glyphs in the frame towards a standard form that may be subsequently compared against a set of glyph exemplar bitmaps. In one embodiment, de-transforming each glyph may include mapping the pixels within each bounding box to a standard-sized bitmap (e.g., 16 pixels by 16 pixels, 32 pixels by 32 pixels, and the like) corresponding to the sizes of a set of glyph exemplar bitmaps.

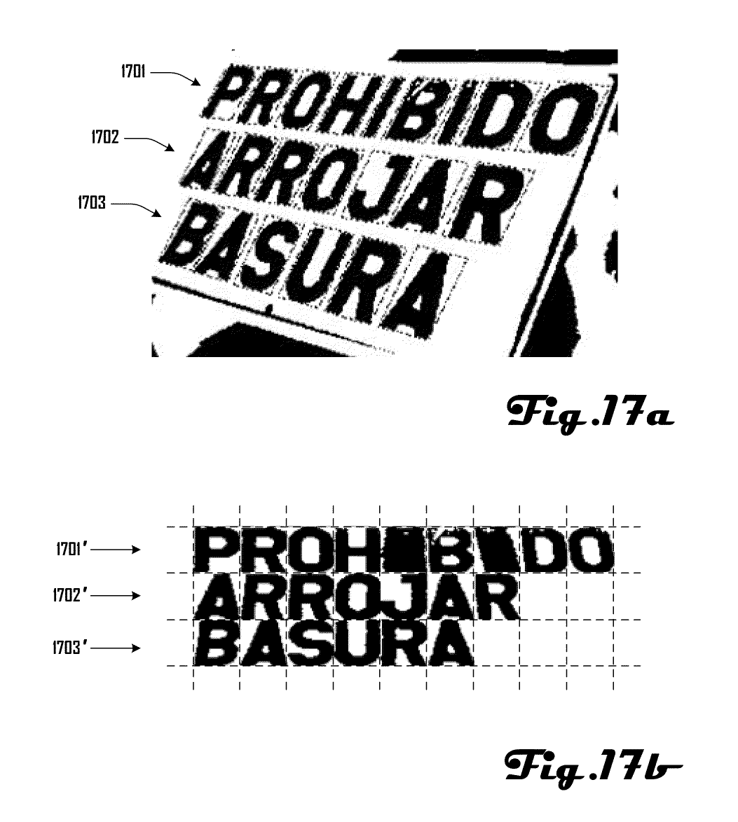

For example, FIG. 17a illustrates three lines of text 1701-1703 that are rotated, skewed, and/or otherwise deformed by perspective and the orientation of the text relative to the camera. FIG. 17b depicts de-transformed lines of text 1701′-1703′, made up of a corresponding set of de-transformed glyph candidates that have a generally standardized orientation and size. In one embodiment, the de-transformed glyph candidates are obtained from the pre-processed and artifact-reduced multi-bit-per-pixel frame image (see blocks 335A-B, discussed below), rather than the one-bit-per-pixel thresholded image (see blocks 355A-B, discussed below).

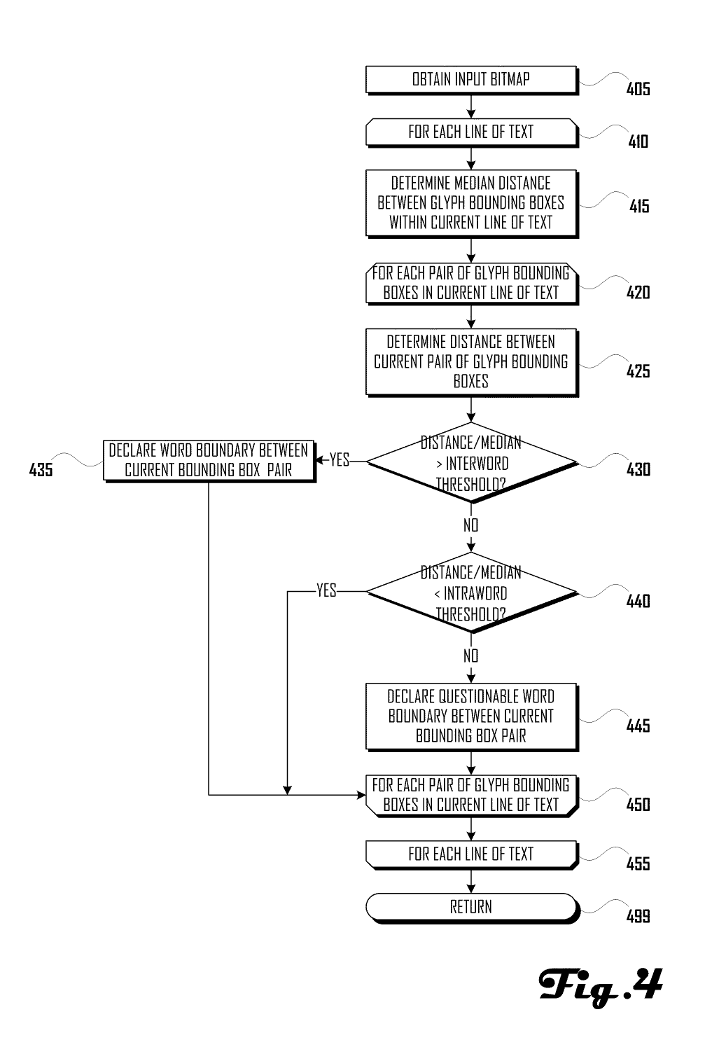

In subroutine block 400 (see FIG. 4, discussed below), routine 200 identifies one or more words in each line of text.

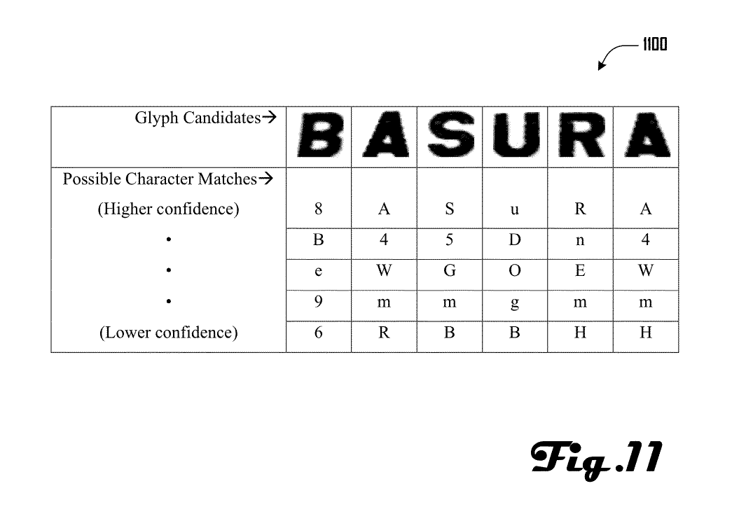

In block 500, routine 200 calls subroutine 500 (see FIG. 5, discussed below) to determine a list of characters that may match each de-transformed glyph, the list being ordered according to a confidence metric. For example, in one embodiment, subroutine 500 may determine lists of possible character matches for glyph candidates corresponding to the word “BASURA” as shown in candidate character matrix 1100 (see FIG. 11). In various embodiments, some or all of subroutine 500 may be performed on a GPU, multi-media co-processor, or other parallel computation unit.

In block 240, routine 200 determines a list of possible recognized word matches for each word according to the lists of possible character matches determined in block 500. For example, using the ordered list of possible character matches illustrated in candidate character matrix 1100 (see FIG. 11), many possible recognized words may be determined, including possible words with relatively high confidences, such as “8ASuRA,” “BASuRA,” and the like, and possible words with low confidences, such as “9mmgmH,” “6RBBHH.”

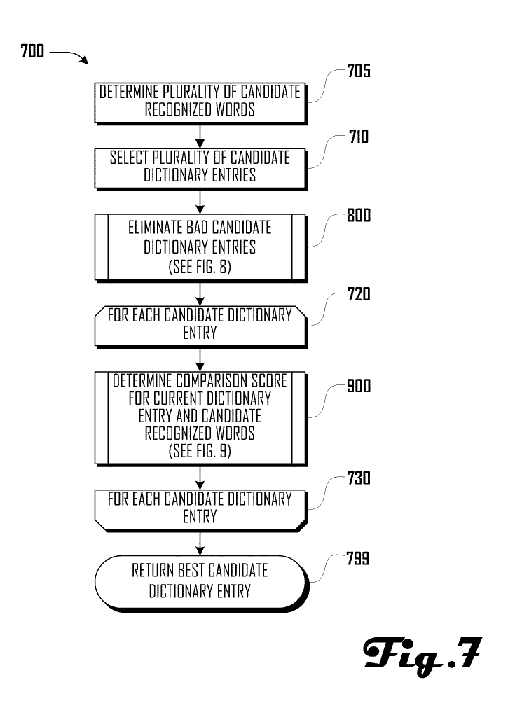

In block 700, routine 200 calls subroutine 700 (see FIG. 7, discussed below) to fuzzy-match the lists of possible recognized word matches for each word against a dictionary of words in a first language. For example, subroutine 700 may fuzzy-string match the possible recognized words listed above against a Spanish language dictionary and determine that “BASURA” is the Spanish word or text that most likely matches the corresponding glyphs.

In block 245, routine 200 translates the recognized first-language word or text into a second language. In one embodiment, the dictionary of words in the first language used by subroutine 700 may also include a translation of each entry into a second language. For example, a dictionary of words in Spanish may include corresponding entries for their English translations (i.e., {“basura”→“trash”}). In some embodiments, translation may further include bi-gram replacement (e.g., so that the Spanish phrase “por favor” translates to “please” in English) and/or idiomatic or grammatical correction to improve the illustrated word-by-word translation process.

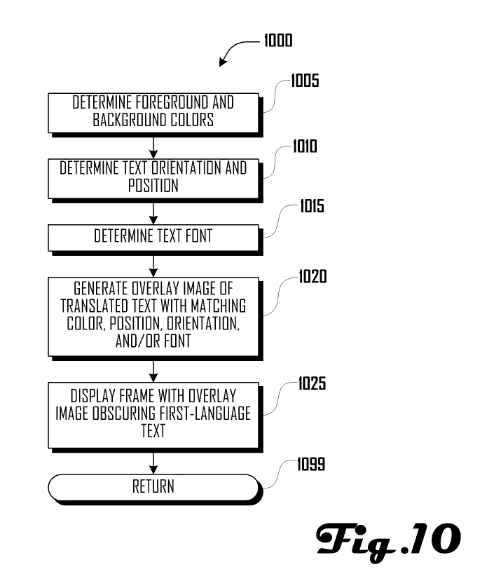

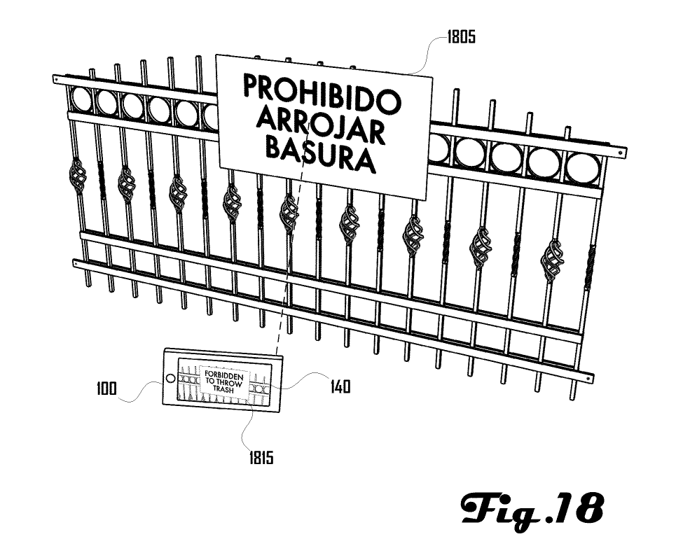

In block 1000, routine 200 calls subroutine 1000 (see FIG. 10, discussed below) to generate and display an augmented reality (“AR”) overlay corresponding to the second-language translation of some or all words in the frame. In one embodiment, an AR overlay comprises a synthetic graphical element that is overlaid on the captured frame when it is displayed to the user, such that the user sees a view of the captured text as it would appear if it had been written in the second language. For example, FIG. 18 depicts AR translating device 100 capturing an image of a sign 1805 including a Spanish-language phrase. However, on its display 140, AR translating device 100 depicts sign 1815 as if it were written in English.

In ending loop block 250, routine 200 iterates back to block 205 to process the next live video frame (if any). Once all live video frames have been processed, routine 200 ends in block 299. In some embodiments, especially those running on a mobile phone or other comparatively low-powered processing device, routine 200 may vary from the illustrated embodiments to facilitate the interactive, real-time aspects of the translation system. For example, in some embodiments, routine 200 may process only a portion of a frame (e.g., only a certain number of glyphs and/or words) on any given iteration. In other words, during a first iteration, routine 200 may recognize and translate only the first 50 letters in the frame, while on a subsequent iteration, routine 200 may recognize and translate only the second 50 letters in the frame.

In such embodiments, a user may see a sign or other written text translated in stages, with a complete translation being displayed after he or she has pointed the translation device at the writing for a brief period of time. Nonetheless, such embodiments may still be considered to operate substantially in real-time to the extent that they dynamically identify and translate text as it comes into view within a live video stream, responding to changes in the view by updating translated text appearing in an automatically-generated overlay to the live video stream, without additional user input. By contrast, non-real-time translation systems may require the user to capture a static image before translation can take place.

FIG. 3 illustrates a frame-processing and text-line identification subroutine 300, in accordance with one embodiment. In block 305, subroutine 300 obtains a pre-processed frame of video. Beginning in starting loop block 310, subroutine 300 processes each pixel in the pre-processed frame.

Between blocks 315-335, subroutine 300 processes the frame via a localized normalization operation to reduce or eliminate undesired image artifacts that may hinder further translation processes, artifacts such as shadows, highlights, reflections, and the like.

In block 315, subroutine 300 determines a pixel-intensity range for a region proximate to the current pixel. In one embodiment, the determined pixel-intensity range disregards outlier pixel intensities in the proximate region (if any) For example, in one embodiment, subroutine 300 may divide the pre-processed frame into sub-blocks (e.g., 16 pixel by 16 pixel sub-blocks) and determine a pixel-intensity range for each block. For each individual pixel, a regional pixel-intensity range may then be determined by interpolating between block-wise pixel intensity ranges.

In one embodiment, block-wise pixel intensity ranges may be determined as in the following exemplary pseudo-code implementation. The outputs, minPic and maxPic, are low-resolution bitmaps that are respectively populated with minimum and maximum pixel intensities for each block of a high-resolution source image. The function GetPixel gets the current pixel intensity from the high-resolution source image. The variable hist stores a histogram with 32 bins, representing intensities within the current block. Once the histogram is filled out, the FindMinMax method determines the range of pixel intensities for the current block, disregarding statistical outliers (which are deemed to represent noise in the source image).

```
void Pic8::ComputeMinAndMax ( int blockSize, Pic8*& minPic, Pic8*&
    maxPic, MemStack *heap)
{
  maxPic = new Pic8(m_width / blockSize, m_height / blockSize, heap);
  minPic = new Pic8(m_width / blockSize, m_height / blockSize, heap);
  // for each pixel in the low-res bitmaps, find the min and max
  for (int y = 0; y < (int)maxPic->m_height; y++)
  {
    for (int x = 0; x < (int)maxPic->m_width; x++)
    {
      CHistogram hist(32);
      for (int by = 0; by < blockSize; by++)
      {
        for (int bx = 0; bx < blockSize; bx++)
        {
          uint8 pixelIntensity = GetPixel(bx + x * blockSize, by +
            y * blockSize);
          // v is a value [0 - 255]. Quantize to [0 - 31] and
          // increment the corresponding histogram bucket.
          hist.hist[pixelIntensity / 8]++;
        }
      }
      uint32 minBlockIntensity, maxBlockIntensity;
      hist.FindMinMax(minBlockIntensity, maxBlockIntensity);
      maxPic->SetPixel(x, y, maxBlockIntensity);
      minPic->SetPixel(x, y, minBlockIntensity);
    }
  }
}
```

In decision block 320, subroutine 300 determines whether the contrast (i.e., the difference between regional minimum and maximum pixel-intensities) of the region proximate to the current pixel is below a pre-determined threshold. If so, then in block 325, subroutine 300 expands the regional pixel-intensity range to avoid amplifying low-contrast noise in the frame. In one embodiment, the contrast threshold may be pre-determined to be 48 (on a scale of 0-255).

In block 330A, subroutine 300 normalizes the current pixel according to the determined regional pixel intensity range. In one embodiment, in block 330B, subroutine 300 also normalizes the inverse of the current pixel according to an inverse of the determined regional pixel intensity range. The locally-normalized and inverse-locally-normalized bitmaps may be respectively suitable for recognizing dark text on a light background and light text on a dark background.

In blocks 335A and 335B, subroutine 300 stores (at least temporarily) the locally-normalized and inverse-locally-normalized pixels to locally-normalized and inverse-locally-normalized bitmaps corresponding to the current frame. In ending-loop block 350, subroutine 300 loops back to block 310 to process the next pixel in the frame (if any).

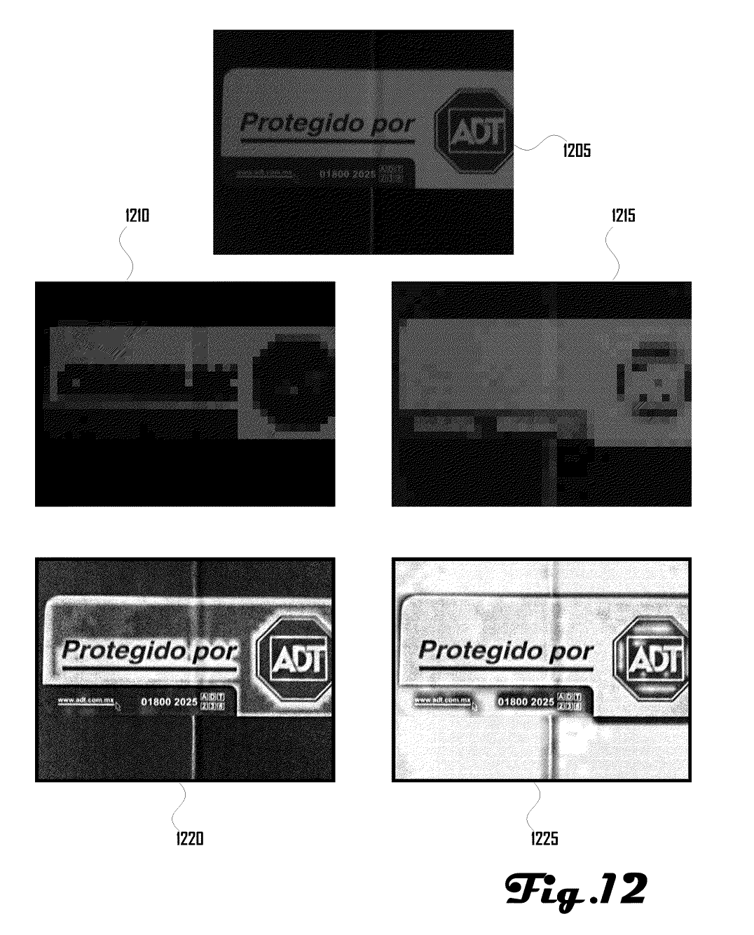

For example, FIG. 12 illustrates a high-resolution input frame 1205, a low-resolution bitmap 1210 populated with minimum pixel intensities (disregarding outliers) for each block of input frame 1205, a low-resolution bitmap 1215 populated with maximum pixel intensities (disregarding outliers) for each block of input frame 1205, an inverse-locally-normalized bitmap 1220, and a locally-normalized bitmap 1225. Low resolution bitmaps 1210 and 1215 are enlarged for illustrative purposes. Locally-normalized bitmap 1225 may be suitable for recognizing dark-on-light text. Inverse-locally-normalized bitmap 1220 may be suitable for recognizing light-on-dark text.

In one embodiment, locally-normalized bitmaps may be determined as in the following exemplary pseudo-code implementation. Inputs minPic and maxPic are low-resolution bitmaps such as may be output from the ComputeMinAndMax pseudo-code (above). The function outputs, leveled and leveledInvert, are locally-normalized grayscale images. The function interpolates four corner range-value pixels in the low-resolution bitmaps to obtain a regional pixel intensity range for each pixel of the high-resolution source image. The variable pixel holds the pixel intensity being normalized from the high-resolution source image (grayscale, in the range 0-255). In one embodiment, blockSize may be 16.

```
void Pic8::LocalThresholdAlgorithm(int blockSize, Pic8 &minPic, Pic8
    &maxPic, Pic8 *leveled, Pic8 *leveledInvert)
{
  leveled->Clear(0);
  leveledInvert->Clear(0);
  // For each pixel in the low-res min/max images
  for (uint32 y = 0; y < maxPic.m_height − 1; y++)
  {
    for (uint32 x = 0; x < maxPic.m_width − 1; x++)
    {
      int blockX = x * blockSize + (blockSize / 2);
      int blockY = y * blockSize + (blockSize / 2);
      uint8 minUL = minPic.GetPixel(x, y);
      uint8 minUR = minPic.GetPixel(x + 1, y);
      uint8 minLL = minPic.GetPixel(x, y + 1);
      uint8 minLR = minPic.GetPixel(x + 1, y + 1);
      uint8 maxUL = maxPic.GetPixel(x, y);
      uint8 maxUR = maxPic.GetPixel(x + 1, y);
      uint8 maxLL = maxPic.GetPixel(x, y + 1);
      uint8 maxLR = maxPic.GetPixel(x + 1, y + 1);
      // loop through a block of pixels in the high res image
      for (int sy = 0; sy < blockSize; sy++)
      {
        uint32 minL = (minUL*(blockSize−sy)+minLL*sy)/blockSize;
        uint32minR=(minUR*(blockSize−sy)+minLR*sy)/blockSize;
        uint32maxL=(maxUL*(blockSize−sy)+maxLL*sy)/blockSize;
        uint32maxR=(maxUR*(blockSize−sy)+maxLR*sy)/blockSize;
        for (int sx = 0; sx < blockSize; sx++)
        {
          intminRange=(minL*(blockSize−sx)+minR*sx)/blockSize;
          intmaxRange=(maxL*(blockSize−sx)+maxR*sx)/blockSize;
          int pixel = GetPixel(blockX + sx, blockY + sy);
          int adjustedMinRange = minRange;
          int maxRangeInvert = maxRange;
          // expand regional pixel-intensity range (if too low)
          int diff = maxRange − minRange;
          if (diff < 48)
          {
            diff = 48;
            maxRangeInvert = minRange + 48;
            adjustedMinRange = maxRange − 48;
          }
          int normalized = ((pixel-adjustedMinRange)*256) / diff;
          int normalizedInvert = 255−(((maxRangeInvert −
                pixel)*256) / diff);
          if (normalized < 0) normalized = 0;
          if (normalized > 255) normalized = 255;
          if (normalizedInvert < 0) normalizedInvert = 0;
          if (normalizedInvert > 255) normalizedInvert = 255;
          leveled->SetPixel(blockX + sx, blockY + sy, normalized);
          leveledInvert->SetPixel(blockX + sx, blockY + sy,
                normalizedInvert);
        }
      }
    }
  }
}
```

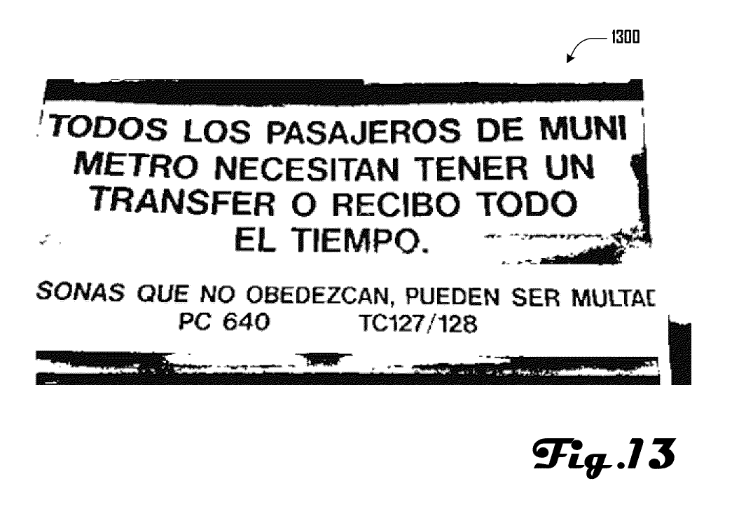

Once the locally-normalized and inverse-locally-normalized bitmaps have been populated with appropriately-normalized pixel intensities, in blocks 355A and 355B, subroutine 300 segments locally-normalized and inverse-locally-normalized bitmaps to create binary images (i.e., a one-bit-per-pixel images). In one embodiment, routine 300 may segment the locally-normalized and inverse-locally-normalized bitmaps via a thresholding operation. FIG. 13 depicts an exemplary locally-normalized bitmap 1300 that has been segmented to a binary image via a thresholding operation.

In blocks 360A and 360B, subroutine 300 identifies lines of text in the segmented locally-normalized and inverse-locally-normalized bitmaps. In one embodiment, identifying lines of text may include determining bounding boxes for any glyphs in the segmented frame via one or more flood-fill operations. Lines of text may be identified according to adjacent “islands” of black.

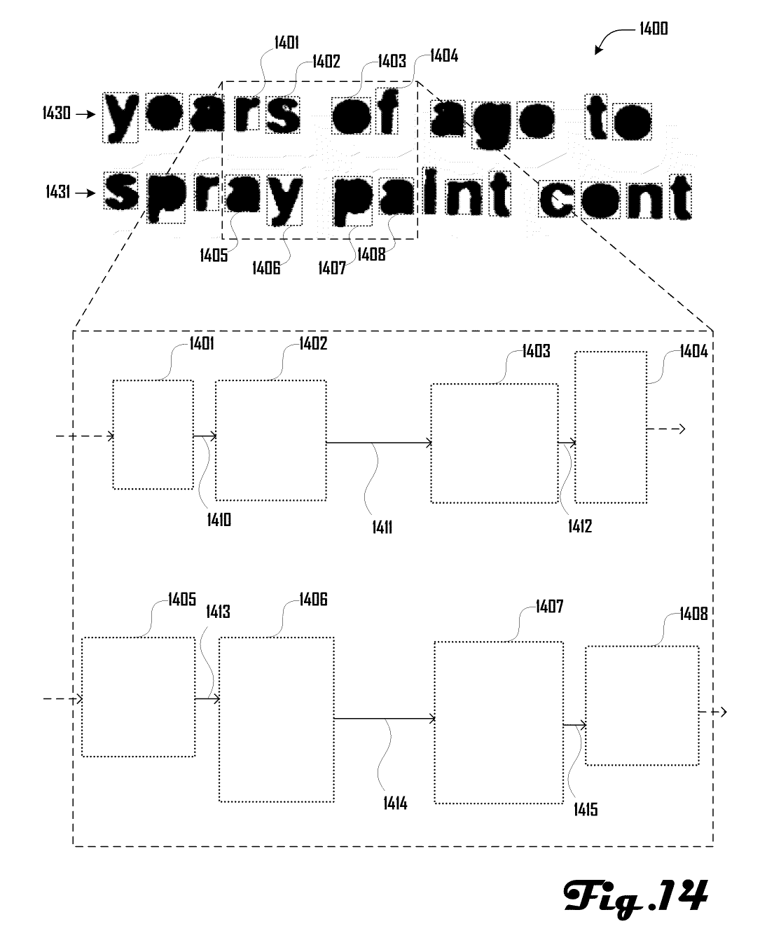

For example, FIG. 14 depicts two lines of text 1430-1431 represented bounding boxes (including bounding boxes 1401-1408) surrounding flood-filled glyphs. In one embodiment, lines of text may be identified by extending a hypothetical line (e.g., lines 1410-1415) from the centers of bounding boxes (e.g. bounding boxes 1401-1408) and identifying neighboring bounding boxes the hypothetical line intersects.

For example, as illustrated in FIG. 14, hypothetical line 1410 from the center of bounding box 1401 intersects bounding box 1402, and so on. In some embodiments, such text-line identification processes may be performed independently on both of the locally-normalized and inverse-locally-normalized bitmaps. Lines of text thereby identified may be flagged as light-on-dark or dark-on-light. In subsequent operations on those lines of text, the image may be inverted or not, as needed.

Referring again to FIG. 3, in block 375, further heuristics may be employed to weed out lines of adjacent bounding boxes that may not represent lines of text. For example, in one embodiment, lines of text may be deemed to include adjacent regions of generally similar size. If adjacent bounding boxes differ in one dimension (e.g., height) by more than a pre-determined ratio (e.g., 2.2), then the prospective line of text may be discarded. Similarly, a line of text may be deemed to include a threshold amount of contrast, with prospective lines that do not meet the threshold being discarded.

Subroutine 300 ends in block 399, returning the identified lines of text to the caller.

FIG. 4 illustrates a subroutine 400 for identifying words within an image of a line of text, in accordance with one embodiment. In block 405, subroutine 400 obtains an input bitmap including one or more lines of text at previously-identified locations. Beginning in opening loop block 410, subroutine 400 processes each line of text. In block 415, subroutine 400 determined a median distance between glyph bounding boxes within the current line of text.

Beginning in opening loop block 420, subroutine 400 processes each pair of bounding boxes in the current line of text. In block 425, subroutine 400 determines a distance between the current bounding box pair. In decision block 430, subroutine 400 determines whether the ratio of the determined distance to the determined median distance exceeds a predetermined inter-word threshold. If the ratio exceeds the inter-word threshold, then subroutine 400 declares a word boundary between the current bounding box pair and proceeds from closing loop block 450 to process the next bounding box pair (if any).

If the ratio does not exceed the inter-word threshold, then in decision block 440, subroutine 400 determines whether the determined ratio is less than a predetermined intra-word threshold. If so, then subroutine 400 proceeds from closing loop block 450 to process the next bounding box pair (if any). If, however, the determined ratio exceeds the predetermined intra-word threshold (but does not exceed the inter-word threshold), then in block 445, subroutine 400 declares a questionable word boundary between the current bounding box pair.

In closing loop block 450, subroutine 400 loops back to block 420 to process the next bounding box pair (if any). In closing loop block 455, subroutine 400 loops back to block 410 to process the next line of text (if any). Subroutine 400 ends in block 499.

FIG. 5 illustrates a fuzzy glyph-identification subroutine 500 in accordance with one embodiment. In beginning loop block 505, subroutine 500 iterates over a plurality of de-transformed glyph candidates that have a generally standardized orientation and size. For example, in one embodiment, subroutine 500 may iterate over the glyph candidates shown in candidate character matrix 1100 (see FIG. 11).

In block 510, subroutine 500 analyzes and/or pre-processes the current glyph candidate. For example, in one embodiment, subroutine 500 determines a plurality of weighted centers of gravity for the current glyph candidate. In an exemplary embodiment, subroutine 500 may determine four centers of gravity for each glyph candidate, one weighted to each corner of the glyph candidate. Such weighted centers of gravity are referred to herein as “corner-weighted” centers of gravity. In other embodiments, more or fewer weighted centers of gravity may be determined, weighted to the corners or to other sets of points within the glyph candidate.

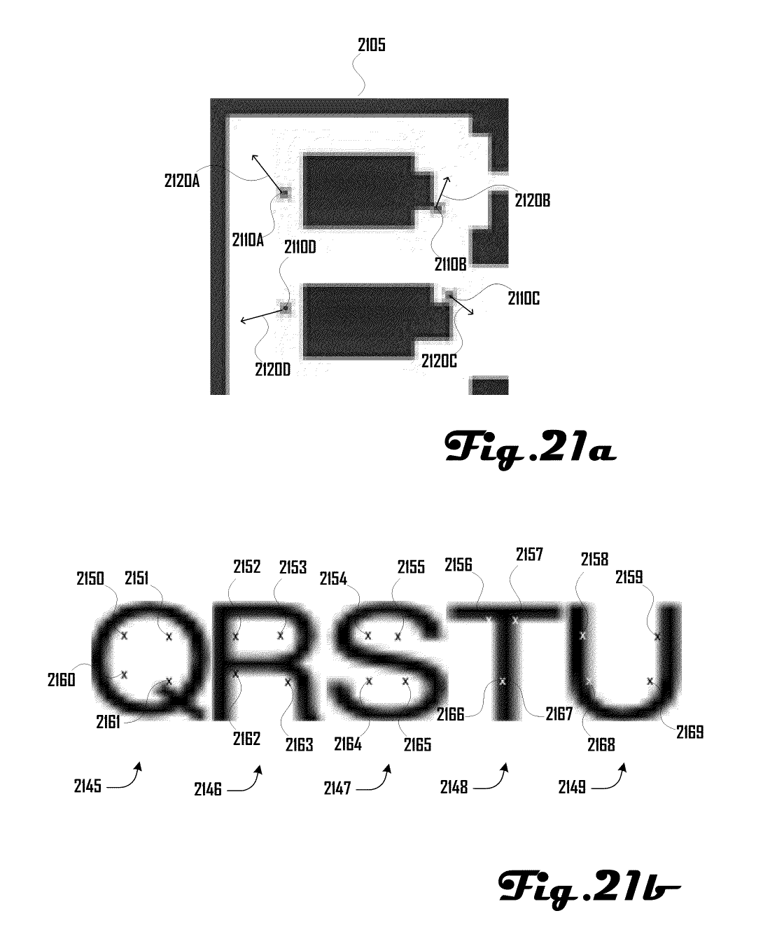

For example, as illustrated in FIG. 21, 16 pixel by 16 pixel bitmap 2105 (corresponding to a glyph candidate) depicts four illustrative (and approximated) corner-weighted centers of gravity 2110A-D.

In one embodiment, a corner-weighted center of gravity routine may be implemented as in the following exemplary pseudo-code implementation. The input, ref_texture, is a 16 pixel by 16 pixel bitmap glyph candidate that likely represents an unknown alphabetic character. The output, fourCorners[ ], includes four (x, y) pairs (i.e., two-dimensional points as defined by the vec2 type) representing the positions of the four corner-weighted centers of gravity. For each (x,y) pixel position in the bitmap glyph candidate, the exemplary implementation gets the corresponding pixel value and if it is “on,” accumulates the (x,y) pixel position multiplied by the respective weights for each of the four corners.

```
int glyphSize = 16;
vec2 fourCorners[4];
float cornerCounts[4];
for (int count = 0; count < 4; count++)
{
    cornerCounts[count] = 0.0;
    fourCorners[count] = vec2(0,0);
}
// for each pixel in the glyph bitmap...
for (int dy = 0; dy < glyphSize; dy++)
{
    for (int dx = 0; dx < glyphSize; dx++)
    {
        // Get a pixel from the glyph
        int pix00 = ref_texture.GetPixel(dx, dy);
        // make the weights for the 4 corners.
        float alphaX = dx / (glyphSize − 1.0);
        float alphaY = dy / (glyphSize − 1.0);
        float alphaNX = (1.0 − alphaX);
        float alphaNY = (1.0 − alphaY);
        if (pix00 > 128) // if pixel is “on”
        {
            // accumulate weighted pixel position
            fourCorners[0] += vec2(dx, dy) * alphaNX * alphaNY;
            fourCorners[1] += vec2(dx, dy) * alphaX * alphaNY;
            fourCorners[2] += vec2(dx, dy) * alphaX * alphaY;
            fourCorners[3] += vec2(dx, dy) * alphaNX * alphaY;
            // sum up the totals
            cornerCounts[0] += alphaNX * alphaNY;
            cornerCounts[1] += alphaX * alphaNY;
            cornerCounts[2] += alphaX * alphaY;
            cornerCounts[3] += alphaNX * alphaY;
        }
    }
}
// normalize it - divide by the max possible counted.
if (cornerCounts[0] != 0.0f) fourCorners[0] /= cornerCounts[0];
if (cornerCounts[1] != 0.0f) fourCorners[1] /= cornerCounts[1];
if (cornerCounts[2] != 0.0f) fourCorners[2] /= cornerCounts[2];
if (cornerCounts[3] != 0.0f) fourCorners[3] /= cornerCounts[3];
// scale to 0-1 for handoff to the GPU.
fourCorners[0] /= glyphSize;
fourCorners[1] /= glyphSize;
fourCorners[2] /= glyphSize;
fourCorners[3] /= glyphSize;
```

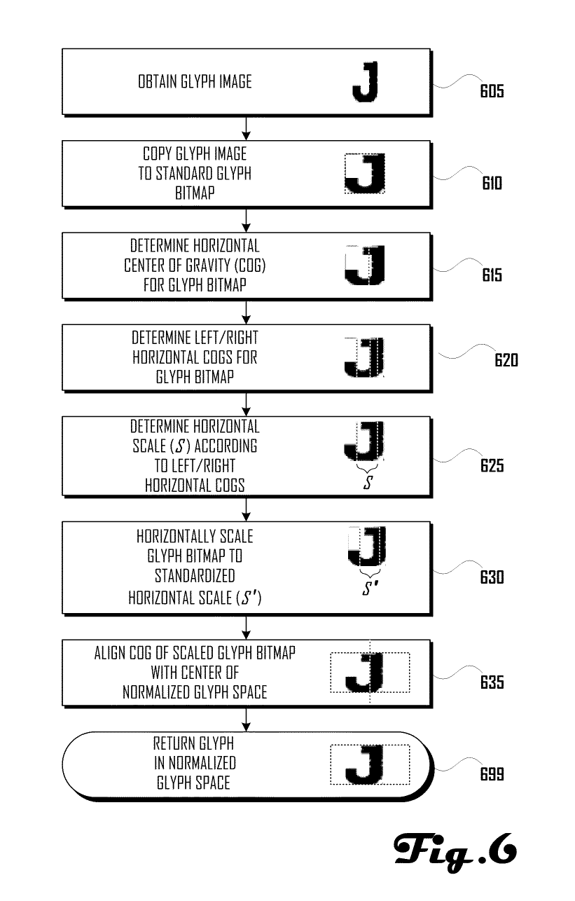

In other embodiments, in block 510, subroutine 500 may pre-processes the current glyph candidate according to subroutine 600, as illustrated in FIG. 6. In block 605, subroutine 600 obtains an image of the current glyph candidate. In block 610, subroutine 600 copies the image to a standard-sized glyph bitmap (e.g., a 32 pixel by 32 pixel bitmap, a 16 pixel by 16 pixel bitmap, or the like), filling the standard-sized bitmap with the image. In block 610, subroutine 600 determines an overall horizontal center of gravity for the standard-sized bitmap. In block 620, subroutine 600 divides the standard-sized bitmap into left and right portions at the overall horizontal center of gravity, and determines left- and right-centers of gravity for the left and right portions, respectively.

In block 625, subroutine 600 determines a horizontal scale (S) or horizontal “image-mass distribution” for the current glyph candidate (analogizing “on” pixels within the image to mass within an object), the horizontal scale being represented by the distance between the left- and right-centers of gravity. In block 630, subroutine 600 horizontally scales the standard-sized bitmap so that horizontal scale (S) conforms to a normalized horizontal scale (S′). For example, in one embodiment, subroutine 600 may determine in block 625 that the current glyph candidate in the standard-sized bitmap has left- and right-centers of gravity that are 9 pixels apart. In block 630, subroutine 600 may determine that according to a normalized horizontal scale, the left- and right-centers of gravity should be 8 pixels apart. In this case, subroutine 600 may then horizontally scale the current glyph candidate to about 89%, such that its left- and right-centers of gravity will be 8 pixels apart.

In block 635, subroutine 600 aligns the overall horizontal center of gravity of the scaled glyph candidate with the center of a bitmap representing a normalized glyph space. For example, in one embodiment, subroutine 600 may align the overall horizontal center of gravity of the scaled glyph candidate with the center of a 64-pixel by 32-pixel normalized bitmap. In some embodiments, a larger or smaller normalized bitmap may be used (e.g., a 32-pixel by 16-pixel normalized bitmap) in place of or in addition to the 64-pixel by 32-pixel normalized bitmap.

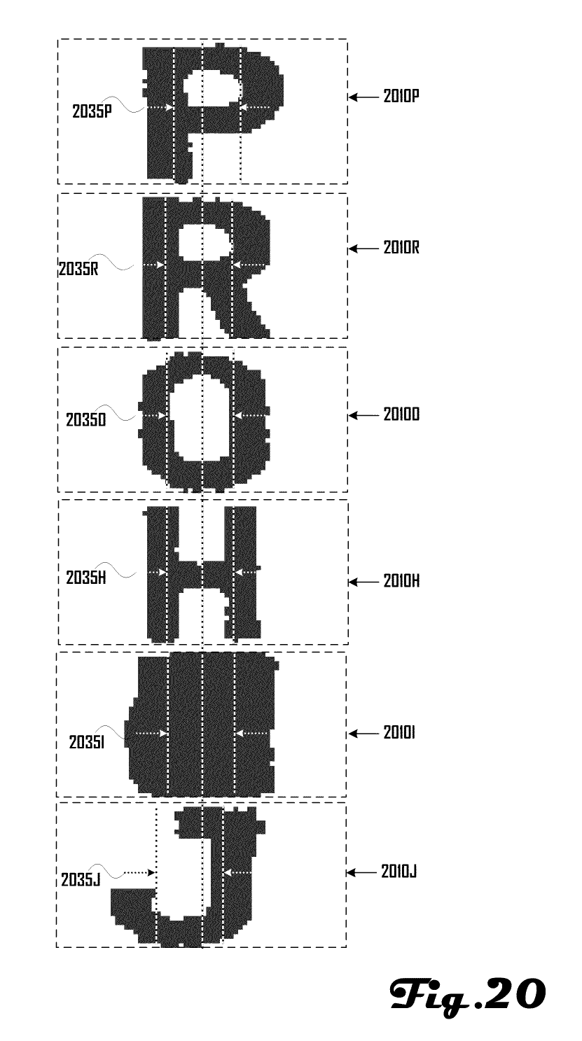

FIG. 20 illustrates several de-transformed glyph candidates (see FIG. 17b) transformed into 64-pixel by 32-pixel normalized bitmaps 2010P, R, O, H, I, J (and enlarged many times for illustrative purposes). The normalized glyph-space candidates are horizontally centered in their normalized bitmaps, and horizontal scales 2035P, R, O, H, I, J for each of normalized bitmaps 2010P, R, O, H, I, J are standardized.

Referring again to FIG. 5, having analyzed and/or pre-processed the current glyph candidate, subroutine 500 compares the current glyph candidate against a plurality of glyph exemplar bitmaps (i.e., bitmaps that represent known characters in a particular font style and case) beginning in starting block 515.

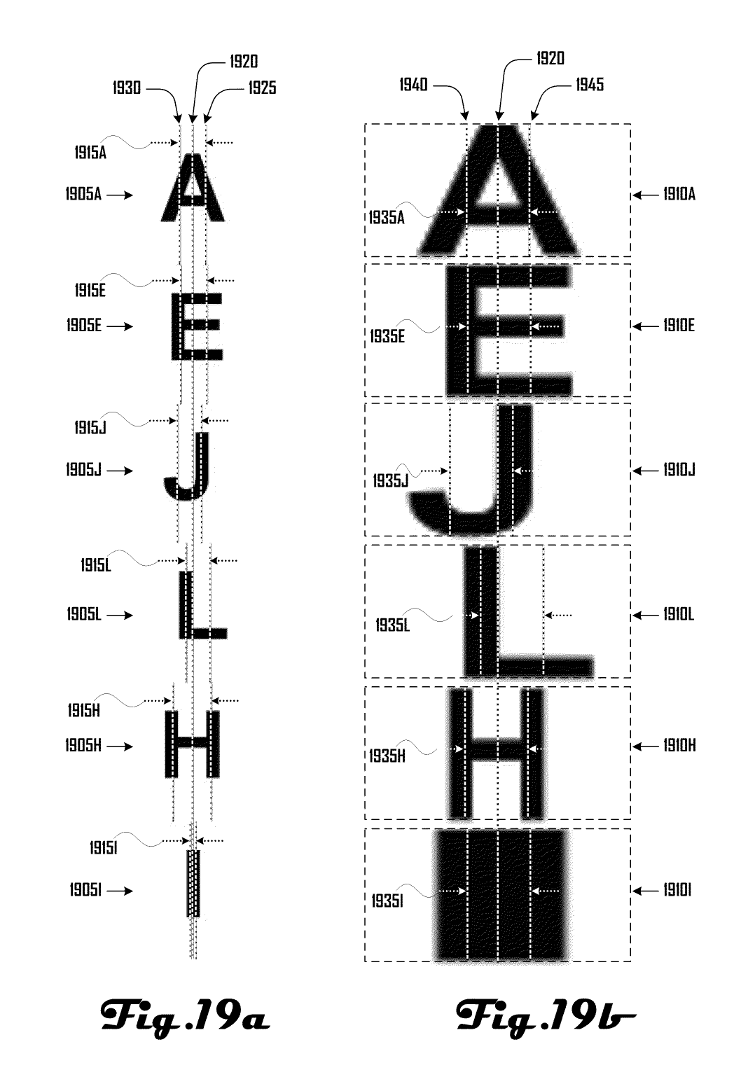

In one embodiment, each of the glyph exemplar bitmaps may have been pre-processed into a normalized glyph space according to subroutine 600, as illustrated in FIG. 6 and discussed immediately above. For example, FIG. 19a illustrates several glyph exemplars 1905A, E, J, L, H, I in a non-normalized glyph space. FIG. 19b illustrates the same exemplars 1910A, E, J, L, H, I transformed into a normalized glyph space. Non-normalized glyph exemplars 1905A, E, J, L, H, I are characterized by a center line 1920, and individual horizontal scales 1915A, E, J, L, H, I, indicated by the distances between each glyph's left- and right-centers of gravity, 1930 and 1925. Normalized exemplars 1910A, E, J, L, H, I have been scaled such that they fill the vertical space in normalized glyph space bitmaps, and such that they have identical horizontal scales 1935A, E, J, L, H, I, indicated by the distances between each glyph's left- and right-centers of gravity, 1940 and 1945.

In alternate embodiments, the normalized glyph space may specify a standard vertical scale, and glyphs may be vertically centered and transformed to have a standard distance between upper- and lower-vertical centers of gravity. In other embodiments, to save processing resources, glyphs may simply be vertically scaled to occupy the entire height of a normalized bitmap, as discussed above and illustrated in FIGS. 6, 19a-b, and 20.

In block 520, subroutine 500 compares the pre-processed glyph candidate with the current glyph exemplar. In one embodiment, the glyph candidate and the current glyph exemplar may each have been previously transformed into a normalized glyph-space according to their respective left- and right-centers of gravity.

In other embodiments, comparing the pre-processed glyph candidate with the current glyph exemplar in block 520 may include obtaining a plurality of corner-weighted centers of gravity for the current exemplar bitmap. In one embodiment, each exemplar bitmap is associated with a plurality of pre-computed corner-weighted centers of gravity. In such an embodiment, obtaining the plurality of corner-weighted centers of gravity for the current exemplar bitmap may include simply reading the pre-computed corner-weighted centers of gravity out of a memory associated with the current exemplar bitmap. In other embodiments, corner-weighted centers of gravity for the exemplar bitmap may be computed in the same manner as the corner-weighted centers of gravity for the glyph candidate, as discussed above.

To illustrate, FIG. 21b depicts several glyph exemplar bitmaps 2145-2149 (enlarged for illustrative purposes), each bitmap having four corner-weighted centers of gravity 2150-2169, and each being associated with a particular character or digit. A complete set of glyph exemplar bitmaps (including exemplar bitmaps 2145-2149) may include exemplars for characters in upper and lower case, in serif and sans-serif fonts, and in a variety of font weights.

Referring again to block 520 in FIG. 5, in one embodiment, subroutine 500 fits the current glyph candidate to the current glyph exemplar bitmap according to their respective corner-weighted centers of gravity. In some embodiments, fitting the current candidate to the current exemplar may comprise i) determining a displacement vector for each corner-weighted center of gravity in the current glyph candidate, the displacement vector mapping to the corresponding corner-weighted center of gravity in the current glyph exemplar bitmap; and ii) warping the current glyph candidate according to each determined displacement vector. For example, FIG. 21a depicts hypothetical illustrative displacement vectors 2120A-D, corresponding to corner-weighted centers of gravity 2110A-D in glyph candidate bitmap 2105.

In some embodiments, it may be desirable to fit the current glyph candidate to the current glyph exemplar bitmap according to their respective corner-weighted centers of gravity because, for example, the current glyph candidate may not have been perfectly de-transformed (e.g., it may still be rotated and/or skewed compared to the standard orientation of the glyph exemplar) and/or the initially captured frame may include shadows, dirt, and/or other artifacts. Fitting the current glyph candidate to each glyph exemplar bitmap using weighted centers of gravity may at least partially compensate for a less-than-perfect glyph candidate.

In some embodiments, a general purpose CPU may determine the displacement vectors, while a GPU, media co-processor, or other parallel processor may warp the glyph candidate according to the displacement vectors.

In block 530, subroutine 500 determines a confidence metric associated with the current glyph candidate bitmap and the current glyph exemplar bitmap. In one embodiment, determining a confidence metric may comprise comparing each pixel in the warped current glyph candidate bitmap with the corresponding pixel in the current glyph exemplar bitmap to determine a score that varies according to the number of dissimilar pixels. In some embodiments, subroutine 500 may compare the glyph candidate bitmap against many glyph exemplar bitmaps in parallel on a media co-processor or other parallel processor. In some embodiments, such parallel comparison operations may include performing parallel exclusive-or (XOR) bitwise operations on the pre-processed glyph candidate and a set of exemplar bitmaps to obtain a difference score. In some embodiments, low-resolution bitmaps (e.g., 32-pixel by 16-pixel bitmaps) may be used for an initial comparison to identify likely matching characters, with higher-resolution bitmaps (e.g., 64-pixel by 32-pixel bitmaps) compared against the identified likely matching characters in several different fonts and/or font weights.

In other embodiments, a confidence metric routine may be implemented as a sum of the squares of the differences in pixel intensities between corresponding pixels in the candidate bitmap and the exemplar bitmap. Such an embodiment may be implemented according to the following exemplary pseudo-code. The inputs, candidate_texture (the warped current glyph candidate bitmap) and exemplar_texture (the current glyph exemplar bitmap), are 16 pixel by 16 pixel bitmaps. The output, confidenceScore, indicates how similar the two bitmaps are, with lower scores indicating a greater similarity (higher confidence).

```
int glyphSize = 16;
long confidenceScore = 0;
// for each pixel in the glyph bitmap...
for (int dy = 0; dy < glyphSize; dy++)
{
    for (int dx = 0; dx < glyphSize; dx++)
    {
        int pix00 = candidate_texture.GetPixel(dx, dy);
        int pix01 = exemplar_texture.GetPixel(dx, dy);
        int diffSqr = pow(pix00 − pix01, 2);
        confidenceScore += diffSqr;
    }
}
```

In some embodiments, in decision block 535, subroutine 500 determines whether the confidence metric satisfies a predetermined criteria. For example, in one embodiment, a confidence metric, as determined by the above pseudo-code confidence metric routine, of 1000 or under may be considered to indicate a good character match, while pixel comparison scores over 1000 are considered bad matches. If the confidence metric satisfies the criteria, then the current glyph exemplar bitmap may be deemed a good match for the current glyph candidate, and in block 540, subroutine 500 stores the character corresponding to the current glyph exemplar bitmap and the current confidence metric in a list of possible character matches, ordered according to confidence metric. See, e.g., the “Possible Character Matches” columns in candidate character matrix 1100 (see FIG. 11).

If, however, subroutine 500 determines in decision block 535 that the confidence metric fails to satisfy the predetermined criteria, then the current glyph exemplar bitmap may be deemed not a good match for the current glyph candidate.

In some cases, the current glyph exemplar bitmap may not be a good match because it includes more than one character. Consequently, when the current glyph exemplar bitmap does not satisfy the confidence criteria, subroutine 500 may attempt to split the current glyph candidate into a pair of new glyph candidates for comparison against the set of glyph exemplars.

In block 545, subroutine 500 determines whether a split criteria is satisfied. In various embodiments, determining whether the split criteria is satisfied may include testing the width of the bounding box in the captured frame that corresponds to the current glyph candidate. For example, if the bounding box is too narrow to likely include two or more characters, then the split criteria may not be satisfied. In some embodiments, determining whether the split criteria is satisfied may also include testing the number of times the current glyph candidate has already been split. For example, in some embodiments, the portion of a frame that corresponds to a particular bounding box may be limited to two or three split operations.

When the split criteria is satisfied, in block 550, subroutine 500 splits the current glyph candidate bitmap into two or more new glyph candidate bitmaps. In one embodiment, splitting the current glyph candidate bitmap may include splitting it along a vertical line (away from the edges of the bitmap) that is determined to include the fewest “on” pixels. The two or more new glyph candidate bitmaps are then added to the queue of glyph candidates to be processed beginning in block 505.

When in decision block 545, subroutine 500 determines that the split criteria is not met, in block 540, subroutine 500 stores the character corresponding to the current glyph exemplar bitmap and the current confidence metric in a list of possible character matches, ordered according to confidence metric. See, e.g., the “Possible Character Matches” columns in candidate character matrix 1100 (see FIG. 11).

In some embodiments, blocks 515-555 may be performed iteratively, in which case, subroutine loops from block 555 back to block 515 process the next glyph exemplar. However, in other embodiments, some of all of blocks 515-555 may be performed in parallel on a GPU, media co-processor, or other parallel computing unit, in which case block 555 marks the end of the glyph exemplar parallel processing kernel that began in block 515.

In block 560, subroutine 500 loops back to block 505 to process the next glyph candidate. After all initial glyph candidates have been processed and scored, beginning in block 560, subroutine 500 attempts to merge low-scoring glyph candidates with adjacent candidates in the event that the low-scoring candidate includes only a portion of a character.

In decision block 565, subroutine 500 determines whether a merge criteria is satisfied. In various embodiments, determining whether the merge criteria is satisfied may include testing the width of the bounding box in the captured frame that corresponds to the current glyph candidate. (See block 225, discussed above.) For example, if the bounding box is too wide to likely include only a portion of a character, then the merge criteria may not be satisfied. In some embodiments, determining whether the merge criteria is satisfied may also include testing the number of times the current glyph candidate has already been merged. For example, in some embodiments, the portion of a frame that corresponds to a particular bounding box may be limited to two or three merge operations.

When the merge criteria is satisfied, in block 570, subroutine 500 merges the current glyph candidate bitmap with an adjacent glyph candidate bitmap to form a merged glyph candidate bitmap. The merged glyph candidate bitmap is then added to the queue of glyph candidates to be processed beginning in block 505.

When (in decision block 565) subroutine 500 determines that the merge criteria is not met, in block 575, subroutine 500 loops back to block 560 to process the next low-scoring glyph candidate (if any). Once all low-scoring glyph candidates have been processed, subroutine 500 ends at block 599, having created a list of possible character matches for each glyph candidate, ordered according to a confidence metric. For example, as illustrated in candidate character matrix 1100 (see FIG. 11), the glyph candidate bitmap corresponding to the letter “B” may have a list of possible character matches (ordered according to confidence) of “8,” “B,” “e,” “9,” and “6.” Similarly, glyph candidate bitmap corresponding to the letter “A” may have a list of possible character matches (ordered according to confidence) of “A,” “4,” “W,” “m,” and “R.”

FIG. 7 illustrates a fuzzy-string match subroutine 700 in accordance with one embodiment. In block 705, subroutine 700 determines an ordered list of candidate recognized words corresponding to a sequence of captured glyphs, according to an ordered list of possible character matches for each glyph. For example, using the ordered list of possible character matches illustrated in candidate character matrix 1100 (see FIG. 11), subroutine 700 may determine a list of candidate recognized words, such as “8ASuRA,” “B45Dn4,” “eWGOEW,” “9mmgmm,” “6RBBHH,” and other possible combinations of possible character matches. For example, in the example illustrated in candidate character matrix 1100, the correct recognized word (“BASURA”) is composed of the second most-confident character in the first character position and the first most-confident characters in character positions two through six. Thus, an ordered list of possible character matches, such as that illustrated in candidate character matrix 1100 may represent hundreds or even thousands of words, when all combinations of possible character matches are considered.

In one embodiment, to find the first-language word that is most likely to correspond to the sequence of captured glyphs, subroutine 700 may simply compare each candidate recognized word with every first-language word entry in a translation dictionary. However, in many embodiments, the translation dictionary may include tens or hundreds of thousands of word entries. In such embodiments, it may be desirable to winnow the translation dictionary word entries to a more manageable size before comparing each with a candidate recognized word.

To that end, in block 710, subroutine 700 selects a plurality of candidate dictionary entries in accordance with the ordered list of candidate recognized words. The plurality of candidate dictionary entries represent a subset of all first-language word entries in the translation dictionary. In one embodiment, selecting the plurality of candidate dictionary entries may include selecting first-language words having a similar number of characters as the candidate recognized words. For example, the exemplary list of candidate recognized words set out above includes words that are six characters in length, so in one embodiment, subroutine 700 may select first-language dictionary entries having six characters.

However, in some cases, the candidate recognized word may include more or fewer characters than the actual word depicted by the corresponding glyphs in the captured frame. For example, a shadow or smudge in the frame near the beginning or end of the word may have been erroneously interpreted as a glyph, and/or one or more glyphs in the word may have been erroneously interpreted as a non-glyph. I.e., the candidate recognized word corresponding to the Spanish word “BASURA” may have extraneous characters (e.g., “i8ASuRA” or “8ASuRA1”) or be missing one or more characters (e.g., “8ASuR” or “ASuRA”).

Accordingly, in some embodiments, selecting the plurality of candidate dictionary entries may also include selecting first-language words having one or two more or fewer characters than the candidate recognized word. For example, the candidate recognized word, “8ASuRA,” has six characters, so in one embodiment, subroutine 700 may select first-language dictionary entries having between five and seven characters or four and eight characters, inclusively.

In some embodiments, to facilitate selecting dictionary entry words having a particular number of characters, the translation dictionary may be sorted by word length first and alphabetically second. In addition, in some embodiments, the translation dictionary may have one or more indices based on one or more leading and/or trailing characters.

In one embodiment, selecting the plurality of candidate dictionary entries may further include selecting first-language words (of a given range of lengths) based on likely leading and/or trailing characters. In one embodiment, subroutine 700 may select words that begin with every combination of likely leading characters and/or that end with every combination of likely trailing characters, the likely leading and/or trailing characters being determined according to the ordered list of possible character matches for each glyph. In some embodiments, subroutine 700 may consider combinations of two or three leading and/or trailing characters. In the examples set out below, combinations of two leading characters are used.

For example, the exemplary ordered list of candidate recognized words (“8ASuRA,” “B45Dn4,” “eWGOEW,” “9mmgmm,” “6RBBHH”) includes the following combinations of two leading characters: “8A,” “84,” “8W,” “8m,” “8R,” “BA,” “B4,” “BW,” “Bm,” “BR,” “eA,” “e4,” “eW,” “em,” “eR,” “9A,” “94,” “9W,” “9m,” “9R,” “6A,” “64,” “6W,” “6m,” “6R.” In some embodiments, mixed alphabetic and numerical combinations may be excluded, leaving the following likely leading letter combinations: “BA,” “BW,” “Bm,” “BR,” “eA,” “eW,” “em” “eR.”

In one embodiment, subroutine 700 may select words of a given range of lengths (e.g., 5-7 characters) that begin with each likely combination of two leading characters. For example, subroutine 700 may select words that begin with “BA . . . ,” “BW . . . ” (if any), “Bm . . . ” (if any), and so on. In some embodiments, to facilitate selecting such words, subroutine 700 may use a hash table or hash function that maps leading letter combinations to corresponding indices or entries in the translation dictionary.

In some embodiments, subroutine 700 may also, in a similar manner, select words of a given range of lengths that end with likely trailing letter combinations according to the ordered list of possible character matches for each glyph. In such embodiments, subroutine 700 may use a “reverse” translation dictionary ordered by word length first and alphabetically-by-trailing-characters second. Such embodiments may also use a hash table or hash function that maps trailing letter combinations to corresponding indices or entries in the “reverse” translation dictionary.

In some embodiments, the plurality of candidate dictionary entries selected by subroutine 700 in block 710 may include approximately 1%-5% of the words in the translation dictionary. In other words, in block 710, subroutine 700 may in some embodiments select between about 1 k-5 k words out of a 100 k translation dictionary.

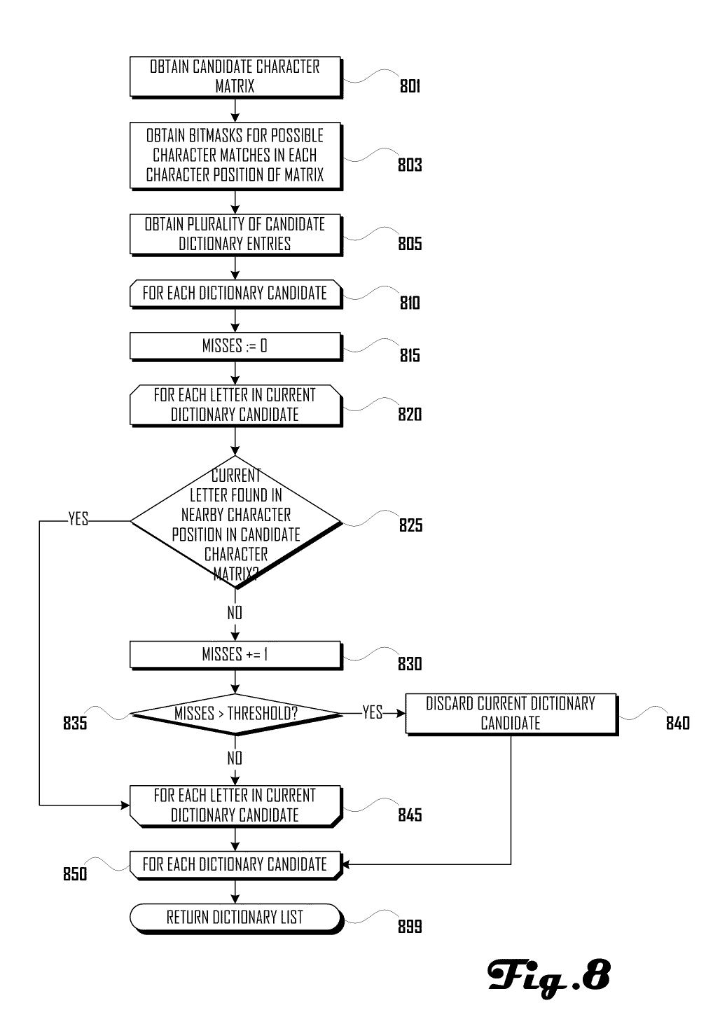

In subroutine block 800 (see FIG. 8, discussed below), subroutine 700 prunes the plurality of candidate dictionary entries to eliminate unlikely candidates according to the ordered list of possible character matches, often winnowing the plurality down to tens or hundreds of not-unlikely candidates.

Beginning in block 720, subroutine 700 iteratively compares each of the plurality of not-unlikely candidate dictionary entries with the plurality of candidate recognized words (e.g., “8ASuRA,” “B45Dn4,” “eWGOEW,” “9mmgmm,” “6RBBHH”).

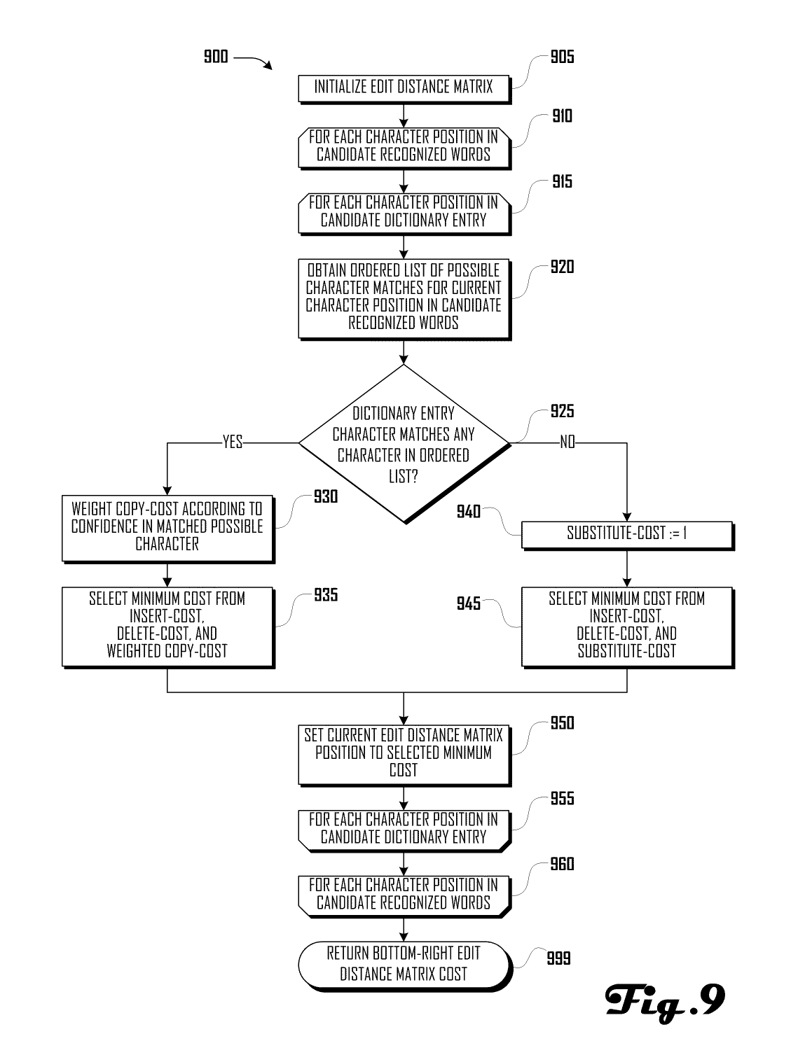

In block 900, subroutine 700 calls subroutine 900 (see FIG. 9, discussed below) to determine a comparison score indicating a level of similarity between the plurality of candidate recognized words and the current candidate dictionary entry. In block 730, subroutine 700 loops back to block 720 to compare the next candidate dictionary entry with the plurality of candidate recognized words.

In block 799, subroutine 700 ends, returning the “best” of the candidate dictionary entries. In some embodiments, the “best” of the candidate dictionary entries may be the candidate dictionary entry whose comparison score indicates the highest level of similarity with the plurality of candidate recognized words.

In some embodiments, subroutine 700 may further process the “best” dictionary entry before returning. For example, in one embodiment, subroutine 700 may determine that a variant of the “best” entry (e.g., a word that differs by one or more letter accents) may be a better match with the glyphs in the captured frame. In such an embodiment, subroutine 700 may return the better variant.

In other embodiments, subroutine 700 may use information from a previously-translated frame to facilitate the fuzzy string match process. For example, in one embodiment, subroutine 700 may retain information about the locations of glyphs and/or words from one frame to the next. In such an embodiment, subroutine 700 may determine that the position of a current word in the current frame corresponds to the position of a previously-processed word in a previous frame (indicating that the same word likely appears in both frames). Subroutine 700 may further determine whether the currently-determined “best” dictionary entry for the current word differs from the “best” dictionary entry that was previously determined for the corresponding word in the previous frame. If a different dictionary entry is determined for the same word, then subroutine 700 may select whichever of the two “best” dictionary entries has a better comparison score. Thus, in some embodiments, data from previous frames may be used to enhance the accuracy of later frames that capture the same text.

FIG. 8 illustrates an unlikely-candidate elimination subroutine 800, in accordance with one embodiment. In block 801, subroutine 800 obtains a candidate character matrix (i.e., an ordered list of possible character matches, such as candidate character matrix 1100, see FIG. 11).

In block 803, subroutine 800 obtains bitmasks representing possible character matches for each character position of the candidate character matrix. In one embodiment, numerical possible character matches (as opposed to alphabetic possible character matches) may be disregarded. In one embodiment, when performing bit-masking operations, subroutine 800 may use a character/bitmask equivalency table such as Table 1.

TABLE 1
CHARACTER/BITMASK EQUIVALENCIES

| Character | |
|---|---|
| (case insensitive) | Mask (Hex) |
| a | 0x1 |
| b | 0x2 |
| c | 0x4 |
| d | 0x8 |
| e | 0x10 |
| f | 0x20 |
| g | 0x40 |
| h | 0x80 |
| i | 0x100 |
| j | 0x200 |
| k | 0x400 |
| l | 0x800 |
| m | 0x1000 |
| n | 0x2000 |
| o | 0x4000 |
| p | 0x8000 |
| q | 0x10000 |
| r | 0x20000 |
| s | 0x40000 |
| t | 0x80000 |
| u | 0x100000 |
| v | 0x200000 |
| w | 0x400000 |
| x | 0x800000 |
| y | 0x1000000 |
| z | 0x2000000 |
| * | 0x0 |

Essentially, Table 1 maps characters to bit positions within a 32-bit integer (or any other integer having at least 26 bits), with the character “a” mapping to the least-significant bit, “b” to the next-least significant bit, and so on. In one embodiment, numbers and other characters not included within the character/bitmask equivalency table may be mapped to 0x0. In other embodiments, other character/bitmask equivalency tables may be employed.

In block 803, subroutine 800 may derive a matrix-character bitmask for a character position by performing a bitwise “OR” operation for the bitmask equivalent of each possible character in that character position, such as in the example set forth in Table 2. For example, in the zeroth character position, the possible characters in the illustrated example are “8,” “B,” “e,” “9,” and “6.” Using the equivalencies set out Table 1, the bitmasks corresponding to each of these possible characters are 0x0, 0x2, 0x10, 0x0, and 0x0, respectively. The bitmask for the zeroth character position may be obtained by combining these possible-character bitmasks using a bitwise OR operation—0x0|0x2|0x10|0x0|0x0—into the zeroth matrix-character-position bitmask 0x12.

TABLE 2
OCR CANDIDATE CHARACTER POSITION BITMASKS

| | Character positions: | | | | | |
|---|---|---|---|---|---|---|
| | 0 | 1 | 2 | 3 | 4 | 5 |
| Possible | 8, B, e, 9, 6 | A, 4, W, | S, 5, G, m, B | U, D, O, g, B | R, n, E, m, H | A, 4, W, |
| characters: | | m, R | | | | m, H |
| Mask | 0x0\|0x2\| | 0x1\|0x0\| | 0x40000\| | 0x100000\| | 0x20000\| | 0x1\|0x0\| |
| derivation: | 0x10\| | 0x400000\| | 0x0\|0x40\| | 0x8\| | 0x2000\| | 0x800000\| |
| | 0x0\|0x0 | 0x1000\| | 0x1000\| | 0x4000\| | 0x10\| | 0x1000\| |
| | | 0x2000 | 0x2 | 0x40\|0x2 | 0x1000\| | 0x80 |
| | | | | | 0x80 | |
| matrix- | 0x12 | 0x403001 | 0x41042 | 0x10404a | 0x23090 | 0x801081 |
| character- | | | | | | |
| position | | | | | | |
| bitmask: | | | | | | |

In block 805, subroutine 800 obtains a plurality of candidate dictionary entries. Beginning in opening loop block 810, subroutine 800 processes each entry in the plurality of candidate dictionary entries. In block 815, subroutine 800 initializes a counter to track the number of non-matching character positions in the current candidate dictionary entry.

Beginning in opening loop block 820, subroutine 800 processes each letter in the current candidate dictionary entry. In decision block 825, subroutine 800 determines whether the current letter of the current candidate dictionary entry matches any of the possible character matches for the current character position or for a nearby character position in the candidate character matrix.

In one embodiment, subroutine 800 may use Table 1 to determine a dictionary-candidate-letter bitmask for the current letter and compare the current dictionary-candidate-letter bitmask to a matrix-character-position bitmask for at least the current character position. For example, in one embodiment, subroutine 800 may perform a bitwise AND operation on the dictionary-candidate-letter bitmask and one or more matrix-character-position bitmasks. If the current dictionary letter matches any of the possible matrix characters, then the result of the AND operation will be non-zero. In some embodiments, subroutine 800 compares the dictionary-candidate-letter bitmask to the matrix-character-position bitmasks for the current character position and for one or more neighboring character positions.

For example, in the example set forth in Table 3, the dictionary-candidate-letter bitmask for the first letter of the dictionary candidate “BASURA” is 0x2. This bitmask may be compared to the matrix-character-position bitmasks for the first two character positions of the possible character matches (i.e., 0x12 and 0x403001, see Table 2) using a bitwise AND operation: 0x2 & (0x12|0x403001). The result is non-zero, indicating that the first letter (“B”) of the dictionary candidate “BASURA” matches at least one possible matrix character for a nearby character position. As shown in Table 3, all of the letters in the dictionary candidate “BASURA” match at least one possible matrix character for a nearby character position, indicating that “BAASURA” may not be an unlikely candidate to match the candidate character matrix.

TABLE 3
DICTIONARY CANDIDATE “BASURA”

| | Character: | | | | | |
|---|---|---|---|---|---|---|
| | B | A | S | U | R | A |
| dictionary- | 0x2 | 0x1 | 0x4000 | 0x100000 | 0x20000 | 0x1 |
| candidate- | | | | | | |
| letter | | | | | | |
| bitmask: | | | | | | |
| dictionary- | 0x2 & | 0x1 & | 0x4000 & | 0x100000 & | 0x20000 & | 0x1 & |
| candidate/ | (0x12\| | (0x12\| | (0x403001\| | (0x41042\| | (0x10404a\| | (0x10404a\| |
| matrix- | 0x403001) ≠ | 0x403001\| | 0x41042\| | 0x10404a\| | 0x23090\| | 0x23090\| |
| characters | 0x0 | 0x41042) ≠ | 0x10404a) ≠ | 0x23090) ≠ | 0x801081) ≠ | 0x801081) ≠ |
| comparison: | | 0x0 | 0x0 | 0x0 | 0x0 | 0x0 |
| Result: | Match | Match | Match | Match | Match | Match |

By contrast, as shown in Table 4 (below), two of the letters (“J” and “C”) in the dictionary candidate “BAJOCA” fail to match at least one possible character for a nearby character position, indicating that “BAJOCA” may be an unlikely candidate to match the candidate character matrix.

If, in decision block 825, subroutine 800 determines that the current letter of the current candidate dictionary entry matches any of the possible character matches for the current character position or for a nearby character position in the candidate character matrix, then subroutine 800 skips to block 845, looping back to block 820 to process the next letter in the current dictionary candidate (if any).

TABLE 4
DICTIONARY CANDIDATE “BAJOCA”

| | Character: | | | | | |
|---|---|---|---|---|---|---|
| | B | A | J | O | C | A |
| dictionary- | 0x2 | 0x1 | 0x200 | 0x4000 | 0x4 | 0x1 |
| candidate- | | | | | | |
| letter | | | | | | |
| bitmask: | | | | | | |
| dictionary- | 0x2 & | 0x1 & | 0x200 & | 0x4000 & | 0x4 & | 0x1 & |
| candidate/ | (0x12\| | (0x12\| | (0x403001\| | (0x41042\| | (0x10404a\| | (0x10404a\| |
| matrix- | 0x403001) ≠ | 0x403001\| | 0x41042\| | 0x10404a\| | 0x23090\| | 0x23090\| |
| characters | 0x0 | 0x41042) ≠ | 0x10404a) == | 0x23090) ≠ | 0x801081) == | 0x801081) ≠ |
| comparison: | | 0x0 | 0x0 | 0x0 | 0x0 | 0x0 |
| Result: | Match | Match | No match | Match | No match | Match |

However, if, in decision block 825, subroutine 800 determines that the current letter of the current candidate dictionary entry fails to match any of the possible character matches for the current character position or for a nearby character position, then in block 830, subroutine 800 increments the “misses” counter. In decision block 835, subroutine 800 determines whether the value of the “misses” counter exceeds a threshold. If so, then the current dictionary candidate is deemed to be an unlikely candidate and is discarded in block 840. In one embodiment, one “miss” (or non-matching character position) is allowed, and candidate dictionary entries with more than one non-matching character position may be discarded as unlikely candidates.

In block 850, subroutine 800 loops back to block 810 to process the next candidate dictionary entry (if any). Subroutine 800 ends in block 899, returning the pruned plurality of non-unlikely candidate dictionary entries.

FIG. 9 illustrates a string-comparison subroutine 900 in accordance with one embodiment. In one embodiment, subroutine 900 may determine a comparison score using a general-purpose string distance function (e.g., a Levenshtein distance function) to determine the minimum “edit distance” that transforms the current candidate recognized word into the current candidate dictionary entry. Using the standard Levenshtein distance function, a “copy” edit operation has a fixed cost of zero, and all “delete,” “insert,” and “substitute” edit operations have a fixed cost of one.

In other embodiments, subroutine 900 may employ a modified string distance function that weights the edit distance according to a confidence metric. In such embodiments, the cost of a “copy” edit operation may be set to a fractional value that varies depending on a confidence metric associated with each particular candidate character in the current candidate recognized word. For example, according to the standard Levenshtein distance function, the case-insensitive edit distance between the string “BASuRA” (as in a candidate recognized word) and the string “BASURA” (as in a candidate dictionary entry) is zero—the sum of the costs of performing six “copy” operations.

However, according to a weighted string distance function, the cost for performing the same substitution would vary depending on the confidence metric or score associated with each copied character. (See block 530, discussed above for a discussion of confidence metrics that indicate how likely it is that a given character corresponds to a given glyph bitmap.)

In block 905, subroutine 900 initializes an edit distance matrix, as in a standard Levenshtein distance function. Beginning in block 910, subroutine 900 iterates over each character position in a plurality of candidate recognized words, each candidate recognized word being made up of a sequence of ordered possible character match lists. Table 5, below, illustrates a candidate character matrix comprising ordered possible character lists (table columns) from which candidate recognized words may be derived.

TABLE 5

| | Character positions | | | | | |
|---|---|---|---|---|---|---|
| | 0 | 1 | 2 | 3 | 4 | 5 |
| Possible characters (Higher confidence) | 8 | A | S | u | R | A |
| . | B | 4 | 5 | D | n | 4 |
| . | e | W | G | O | E | W |
| . | 9 | m | m | g | m | m |
| Possible characters (Lower confidence) | 6 | R | B | B | H | H |

Beginning in block 915, subroutine 900 iterates over each character position in a candidate dictionary entry. For example, Table 6, below, illustrates the candidate dictionary entry “BASURA.”

TABLE 6

| | Character positions | | | | | |
|---|---|---|---|---|---|---|
| | 0 | 1 | 2 | 3 | 4 | 5 |
| Candidate dictionary entry | B | A | S | U | R | A |

In block 920, subroutine 900 obtains an ordered list of possible characters for the current character position. For example, in block 920, subroutine 900 may obtain a column of possible characters from Table 5 for the current character position (i.e., for the zeroth character position, in descending order of confidence, “8,” “B,” “e,” “9,” and “6”).

In decision block 925, subroutine 900 determines whether the dictionary entry character at the current character position (i.e., “B” for the zeroth character position) matches any of the current ordered list of possible characters. For example, subroutine 900 determines whether the zeroth character from Table 6 (“B”) matches any of the characters from the zeroth column of Table 5. In this case, the zeroth dictionary entry character from Table 6 matches the second most likely character from the zeroth column from Table 5.

If the dictionary entry character at the current character position matches any of the current ordered list of possible characters, then a “copy” edit operation may be indicated, and in block 930, subroutine 900 determines a weighted copy cost for the current character position. In one embodiment, the weighted copy cost may be determined according to the matched character's position within the current ordered list of possible characters.

TABLE 7

| | Weighted copy cost |
|---|---|
| Higher confidence matched character position | 0.0 |
| . | 0.2 |
| . | 0.4 |
| . | 0.6 |
| Lower confidence matched character position | 0.8 |

For example, Table 7, above, lists an exemplary ordered list of copy costs determined according to the matched character's position within the current ordered list of possible characters. In other embodiments, a character's copy cost may be computed from the character's confidence metric, such as a sum of squares of differences in pixel intensities as discussed above in reference to block 530.

Thus, in the illustrative example, the weighted “copy” cost corresponding to the zeroth character position in Table 5 and Table 6 may be 0.2. By contrast, the weighted copy costs corresponding to the first through fifth character positions may be 0.0 (assuming case-insensitive comparisons). In block 935, subroutine 900 selects a minimum cost among an insert cost, a delete cost, and a weighted copy cost for the current edit distance matrix position.

If in decision block 925, subroutine 900 determines that the dictionary entry character at the current character position does not match any of the current ordered list of possible characters, then a “substitute” edit operation (rather than a copy operation) may be indicated, and in block 940, subroutine 900 sets the cost of a substitute operation to one. In block 945, subroutine 900 selects a minimum cost among an insert cost, a delete cost, and a substitute cost for the current edit distance matrix position.

In block 950, subroutine 900 sets the current edit distance matrix position (determined according to the current character positions in the candidate recognized words and the candidate dictionary entry) to the minimum cost selected in block 935 or block 945.

In block 955, subroutine 900 loops back to block 915 to process the next character position in the candidate dictionary entry. In block 960, subroutine 900 loops back to block 910 to process the next character position in the candidate recognized words.

After all character positions have been processed, subroutine 900 ends in block 999, returning the cost value from the bottom-right entry in the edit distance matrix. In some embodiments, some or all of subroutine 900 may be performed on a media co-processor or other parallel processor.

One embodiment of subroutine 900 may be implemented according to the following pseudo-code. The argument “word” holds an array of candidate recognized words (see, e.g., Table 5). The argument “lenS” holds the length of the strings in the word array. The argument “*t” points to a string that represents the candidate recognized word (see, e.g., Table 6). The argument “lenT” holds the length of the candidate recognized word. Other embodiments may be optimized in various ways, such as to facilitate early exit from the routine, but such optimizations need not be shown to disclose an illustrative embodiment.

```
float mat[32][32];
int MAX_LETTER_MATCHES = 5;
void InitLevenshteinDistance( )
{
  for (int i=0; i <= 31; i++) mat[i][0] = (float)i;
  for (int j=0; j <= 31; j++) mat[0][j] = (float)j;
}
float FuzzyLevenshteinDistance(
      unsigned char word[MAX_LETTER_MATCHES][256],
      int lenS,
      const char *t,
      int lenT
) {
  for (int i=1; i<=lenS; i++)
  {
    for (int j=1; j<=lenT; j++)
    {
      float cost = 1; // substitution cost
      for (int count = 0; count < MAX_LETTER_MATCHES;
      count++)
      {
        if (word[count][(i−1)] == t[j−1])
        {
          // set weighted copy cost
          cost = (float)count / MAX_LETTER_MATCHES;
          break;
        }
      }
      mat[i][j] = fMin3(
        mat[i−1][j] + 1,  // deletion
        mat[i][j−1] + 1,  // insertion
        mat[i−1][j−1] + cost  // substitution or copy
      );
    }
  }
  return mat[lenS][lenT];
}
```

FIG. 10 illustrates an augmented reality overlay subroutine 1000 in accordance with one embodiment. In block 1005, subroutine 1000 determines text foreground and text background colors according to the captured video frame. In block 1010, subroutine 1000 determines text orientation and position information. In some embodiments, determining text orientation and position information may include using bounding box, orientation, and/or transformation information such as that determined by subroutine 300 (see FIG. 3, discussed above).

In block 1015, subroutine 1000 determines font information for text in the frame. In some embodiments, subroutine 1000 may attempt to determine general font characteristics such as serif or sans-serif, letter heights, stroke thicknesses (e.g., font weight), letter slant, and the like.

In block 1020, subroutine 1000 generates an overlay image including translated text having similar position, orientation, and font characteristics of first-language text from the original video frame.

In block 1025, subroutine 1000 displays the original video frame with the generated overlay obscuring the first-language text. (See, e.g., FIG. 18, discussed above.) Subroutine 1000 ends in block 1099.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the embodiments discussed herein.

1. A personal-mobile-device-implemented real-time augmented-reality machine translation method comprising:
capturing a live video stream by a video capture device associated with the personal mobile device;
automatically processing a plurality of frames of said live video stream, including:
automatically identifying, by the personal mobile device, a plurality of image-regions within the current frame, said plurality of image-regions respectively depicting a plurality of glyphs collectively representing at least one word in a first language;
determining, by the personal mobile device, a text position and a text orientation for said at least one word within the current frame;
determining, by the personal mobile device, a candidate character matrix comprising an ordered plurality of candidate characters for a plurality of character positions corresponding to said plurality of glyph image-regions;
selecting, by the personal mobile device according to said candidate character matrix, a recognized text from a first-language dictionary, said recognized text corresponding to said at least one word in said first language;
translating, by the personal mobile device, said recognized text into a second language;
generating, by the personal mobile device, an image comprising said second-language translation oriented according to said determined text orientation;
dynamically overlaying, by the personal mobile device, said generated image on the current frame at said determined text position such that said second-language translation obscures said at least one word in said first language; and
displaying the current frame and said overlaid generated image on a display associated with the personal mobile device.

2. The method of claim 1, wherein determining said candidate character matrix comprises transforming each of said plurality of glyph image-regions into a normalized glyph space characterized by a pre-determined size, horizontal center point, and horizontal image-mass distribution.

3. The method of claim 2, wherein selecting said recognized text from said first-language dictionary comprises comparing each of said plurality of glyph image-regions to a plurality of letter bitmaps pre-transformed into said normalized glyph space.

4. The method of claim 2, wherein transforming each of said plurality of glyph image-regions into a normalized glyph space comprises:
calculating a left center of gravity and a right center of gravity for each of said plurality of glyph image-regions; and
horizontally scaling each of said plurality of glyph image-regions such that each resulting pair of horizontally scaled left and right centers of gravity are a standardized distance apart from one another.

5. The method of claim 1, wherein determining said text orientation for said at least one word within the current frame comprises:
vectorizing at least one of said plurality of glyphs respectively depicted in said plurality of image-regions into a plurality of connected line segments; and
determining a vertical text orientation of said at least one of said plurality of glyphs according a plurality of tilts of said plurality of connected line segments.

6. The method of claim 1, further comprising for each of said plurality of frames of said live video stream: pre-processing the current frame via a localized normalization operation.

7. The method of claim 6, wherein said localized normalization operation comprises, for each pixel within the current frame:
determining a regional pixel-intensity minimum and a regional pixel-intensity maximum for a region of the current frame proximate to the current pixel, disregarding regional pixel intensities that are statistical outliers (if any);
determining a regional normalization range according to said regional pixel-intensity minimum, said region pixel-intensity maximum, and a pre-determined intensity-range minimum threshold; and
normalizing a pixel-intensity of the current pixel according to said regional normalization range and at least one of said regional pixel-intensity minimum and said regional pixel-intensity maximum.

8. The method of claim 1, wherein selecting said recognized text from a first-language dictionary comprises:
selecting a plurality of candidate dictionary entries according to said candidate character matrix; and
comparing at least some of said plurality of candidate dictionary entries with said candidate character matrix according to an edit distance function having a weighted-copy edit operation.

9. The method of claim 8, wherein selecting said plurality of candidate dictionary entries comprises selecting a first plurality of dictionary entries according to a determined range of word lengths corresponding to said at least one word in said first language and according to at least one of i) one or more leading candidate characters, and ii) one or more trailing candidate characters.

10. The method of claim 9, wherein selecting said plurality of candidate dictionary entries further comprises:
obtaining for each of said plurality of candidate dictionary entries, a set of one or more candidate-character bitmasks, each candidate-character bitmask representing a character at one of the character positions of the current candidate dictionary entry;
generating for each character position of said candidate character matrix, a set of one or more matrix-character bitmasks, each representing a plurality of possible characters at a character position of said candidate character matrix;
selecting a plurality of said sets of candidate-character bitmasks that at least roughly match said set of matrix-character bitmasks; and
selecting a subset of said plurality of dictionary entries that respectively correspond to said selected roughly-matching plurality of sets of candidate-character bitmasks.

11. The method of claim 10, wherein generating said set of one or more matrix-character bitmasks comprises: for each character position within said candidate character matrix, determining an integer corresponding to the current character position, wherein said determined integer comprises at least 26 bits, and wherein each bit of said determined integer is set or not set based at least in part on whether a corresponding alphabetic character is a member of the ordered plurality of candidate characters at the current character position within said candidate character matrix.

12. The method of claim 10, wherein generating said set of one or more matrix-character bitmasks comprises:
for each character position within said candidate character matrix, determining an integer corresponding to the current character position, wherein said determined integer comprises at least 26 bits, and wherein each bit of said determined integer is set or not set according to whether a corresponding alphabetic character is a member of a character set comprising:
a first ordered plurality of candidate characters at the current character position within said candidate character matrix, and
at least one other ordered plurality of candidate characters adjacent to the current character position within said candidate character matrix.

13. The method of claim 8, wherein said weighted-copy edit operation assigns a copy-cost to a matching character according to the matching character's position in a corresponding one of said ordered pluralities of candidate characters.

14. A personal mobile apparatus comprising:
a video capture component configured to capture a live video stream;
a display;
a processor; and
a memory storing a first-language dictionary and instructions that, when executed by the processor, configure the apparatus to perform a real-time augmented-reality machine translation method comprising, automatically processing each of a plurality of frames of said live video stream, including:
automatically identifying a plurality of image-regions within the current frame, said plurality of image-regions respectively depicting a plurality of glyphs collectively representing at least one word in a first language;
determining a text position and a text orientation for said at least one word within the current frame;
determining a candidate character matrix comprising an ordered plurality of candidate characters for a plurality of character positions corresponding to said plurality of glyph image-regions;
selecting, according to said candidate character matrix, a recognized text from said first-language dictionary, said recognized text corresponding to said at least one word in said first language;
translating said recognized text into a second language;
generating an image comprising said second-language translation oriented according to said determined text orientation;
dynamically overlaying said generated image on the current frame at said determined text position such that said second-language translation obscures said at least one word in said first language; and
displaying the current frame and said overlaid generated image on said display.

15. The apparatus of claim 14, wherein the memory stores further instructions to configure the apparatus to transform each of said plurality of glyph image-regions into a normalized glyph space characterized by a pre-determined size, horizontal center point, and horizontal image-mass distribution when determining said candidate character matrix.

16. The apparatus of claim 15, wherein the memory stores further instructions to configure the apparatus to compare each of said plurality of glyph image-regions to a plurality of letter bitmaps pre-transformed into said normalized glyph space when selecting said recognized text from said first-language dictionary.

17. The apparatus of claim 16, further comprising a parallel-processing unit, and wherein the memory stores further instructions to configure said parallel-processing unit to compare each of said plurality of glyph image-regions to said plurality of letter bitmaps pre-transformed into said normalized glyph space.

18. The apparatus of claim 14, wherein the memory stores further instructions to configure the apparatus to select said recognized text from said first-language dictionary by:
selecting a plurality of candidate dictionary entries according to said candidate character matrix; and
comparing at least some of said plurality of candidate dictionary entries with said candidate character matrix according to an edit distance function having a weighted-copy edit operation.

19. The apparatus of claim 18, further comprising a parallel-processing unit, and wherein the memory stores further instructions to configure said parallel-processing unit to comparing at least some of said plurality of candidate dictionary entries with said candidate character matrix according to said edit distance function having said weighted-copy edit operation.

20. A non-transient computer-readable storage medium having stored thereon instructions that, when executed by a processor, configure the processor to perform a real-time augmented-reality machine translation method comprising, automatically processing each of a plurality of frames of a live video stream, including:
automatically identifying a plurality of image-regions within the current frame, said plurality of image-regions respectively depicting a plurality of glyphs collectively representing at least one word in a first language;
determining a text position and a text orientation for said at least one word within the current frame;
determining a candidate character matrix comprising an ordered plurality of candidate characters for a plurality of character positions corresponding to said plurality of glyph image-regions;
selecting, according to said candidate character matrix, a recognized text from a first-language dictionary, said recognized text corresponding to said at least one word in said first language;
translating said recognized text into a second language;
generating an image comprising said second-language translation oriented according to said determined text orientation;
dynamically overlaying said generated image on the current frame at said determined text position such that said second-language translation obscures said at least one word in said first language; and
displaying the current frame and said overlaid generated image on a display associated with the personal mobile device.
